(19) United States
(12) Patent Application Publication
(10) Pub. No.: US 2005/0090612 A1
(43) Pub. Date: Apr. 28, 2005

(54) Polymerization process and materials for biomedical applications

(76) Inventors: David S Soane, Piedmont, CA (US); Shaobin Fan, Castro Valley, CA (US); Toshiaki Hino, Berkeley, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/502,975

(22) PCT Filed: Feb. 10, 2003
(86) PCT No.: PCT/US03/04277

Related U.S. Application Data
(60) Provisional application No. 60/357,578, filed on Feb. 15, 2002.
(60) Provisional application No. 60/366,828, filed on Mar. 22, 2002.

(51) Int. Cl. C08K 3/00

(52) U.S. Cl. 524/800

(57) ABSTRACT

A molded component or article for biomedical use is prepared from a crosslinkable non-water-soluble polymer which when crosslinked and saturated with water forms a hydrogel. The polymer is formulated as a composition containing a non-aqueous diluent in addition to the polymer, the diluent being present in a volumetric proportion that is substantially equal to the volumetric proportion of water in the hydrogel that would be formed when the polymer is crosslinked and saturated with water. The composition is cast in a mold where the composition is exposed to conditions that cause crosslinking to occur by a reaction to which the non-aqueous diluent is inert. The crosslinking reaction produces a molded non-aqueous gel which is then converted to a hydrogel by substituting an aqueous liquid such as water or physiological saline for the non-aqueous diluent. The use of a molding composition whose curing consists essentially entirely of crosslinking results in a molding process that entails little or no shrinkage, and dimensional integrity is maintained up through the formation of the hydrogel by using the non-aqueous diluent in essentially the same volumetric proportion as water in the hydrogel.

### CROSS REFERENCE TO RELATED APPLICATIONS

This application claims the benefits of co-pending U.S. provisional patent applications No. 60/357,578, filed on Feb. 15, 2002, and 60/366,828, filed on Mar. 22, 2002, for all purposes legally capable of being served thereby. The contents of each of these provisional patent applications are incorporated herein by reference in their entirety, as are all other patent and literature references cited throughout this specification.

### BACKGROUND OF THE INVENTION

1. Field of the Invention

The present invention relates to a polymerization process for the production of polymeric moldings, such as medical device moldings and optical lenses, preferably contact lenses, intraocular lenses, and ophthalmic lenses, in which crosslinkable polymeric precursor mixtures are synthesized and molded. The invention also relates to the novel crosslinkable polymeric precursor mixtures and moldings obtainable in accordance with that process.

2. Description of the Prior Art

Polymeric materials have been widely used in biomedical applications such as contact lenses, intraocular lenses, and ophthalmic lenses. Examples of other polymeric biomedical moldings are bandages or wound closure devices, heart valves, coronary stents, artificial tissues and organs, and films and membranes. The advantage of polymeric materials is that a large number of materials are available to obtain desired mechanical, physical, chemical, and optical properties of products by selecting the components and compositions of materials. The properties of polymeric materials also depend on their morphologies which can be manipulated by adjusting the processing conditions such as mixing.

In biomedical applications of polymeric materials, major concerns are biocompatibility and toxicity. Consequently, all biomedical devices are required to meet the stringent regulations administered by the US Food & Drug Administration (FDA). Concerns of biocompatibility and toxicity affect the selection of materials as well as the process design.

In order to ensure biocompatibilty and safety, a common practice is to employ a post-production treatment on polymeric materials for biomedical applications. For entities made from direct polymerization of liquid monomers (i.e., monomer-based casting system), tedious extraction treatment is often required, in which a biomedical product or device is immersed in water or other non-toxic liquid for a prolonged period, often hours at elevated temperatures. During the extraction process, residual monomers, catalysts, and other harmful species are removed by diffusion which proceeds slowly. Upon completing an extraction step, the treated polymeric part is essentially free of toxic ingredients and can be used safely for a biomedical use. Thus, in the production of polymeric materials for biomedical applications, the monomer-based casting system is costly because it requires additional equipment, time and labor for the postproduction extraction step which increases the cost and reduces the efficiency of production significantly.

For the production of precision parts such as contact lenses, intraocular lenses, and ophthalmic lenses, another drawback of a monomer-based casting system is that the shape of the cured article often fails to replicate precisely the geometry of the mold cavity because of the shrinkage realized upon curing monomers.

When the shrinkage is the major concern of moldings, polymeric products may also be produced from polymer resins by injection molding, compression molding, or other techniques well-known and commonly practiced in the art. However, these techniques require high processing temperatures and are not suitable for processing thermally sensitive polymers such as the high-refractive index polymers useful for ophthalmic lenses.

Thus, it would be desirable to have an efficient means by which polymeric products for biomedical applications could be produced without costly purification, undue shrinkage, or exposing polymers to harsh processing conditions.

### SUMMARY OF THE INVENTION

The present invention is aimed at alleviating or reducing the above-stated problems. The invention relates to a process for the production of moldings, in particular medical device moldings, more particularly optical lens moldings which exhibit low shrinkage upon cure compared to curable liquid formulations known in the art and/or do not require extraction steps prior to their intended use. Preferred moldings are contact lenses, intraocular lenses, and ophthalmic lenses. Examples of other applicable moldings are biomedical moldings such as bandages or wound closure devices, heart valves, coronary stents, artificial tissues and organs, and films and membranes.

Shrinkage of the polymer during the molding stage is reduced or eliminated in accordance with this invention by using a molding composition that includes a preformed non-water-soluble polymer that is capable of crosslinking, instead of a monomer. The composition also contains a non-aqueous diluent that is inert to the crosslinking reaction. The volumetric proportion of non-aqueous diluent in the molding composition is derived from the known characteristics that the polymer will exhibit after the polymer has been crosslinked and saturated with water. Specifically, the polymer, once crosslinked and saturated with water or an aqueous liquid such as physiological saline forms a hydrogel that contains a known volumetric proportion of water determined by the molecular characteristics of the crosslinked polymer itself, and that volumetric proportion is used as the volumetric proportion of the non-aqueous diluent in the molding composition with the not yet crosslinked polymer. Crosslinking of the molding composition during the molding stage then produces a non-aqueous gel which in a succeeding step is replaced by an aqueous liquid to form the hydrogel, the volumetric proportion of water in the hydrogel being substantially the same as the volumetric proportion of non-aqueous diluent in the composition that is placed in the mold. The result is a substantially isometric exchange of water or aqueous liquid for the non-aqueous diluent. The term “aqueous liquid” is used herein to denote either water or an aqueous solution, particularly a dilute aqueous solution such as physiological saline.

The term “substantially equal” as used herein in connection with the volumetric proportions of non-aqueous diluent and water denotes that a small difference between the volumetric proportions and hence a small volume change upon the substitution of the aqueous liquid for the non-aqueous diluent may occur and is still within the scope of the invention. The only limitation is that any such change be within tolerance limits established by the industry in which the product is manufactured and sold and by any regulatory limits that apply to the product. Thus, for contact lenses, for example, any deviation between the volume of the non-aqueous gel and the hydrogel that is within the industry-accepted tolerance limits for contact lenses is acceptable. Such tolerance limits are known among those skilled in the art for each type of molded product in addition to being readily determinable from literature published by the appropriate regulatory agencies.

The process makes use of a polymeric precursor mixture synthesized at low temperatures that is shaped into a desired geometry and cured. Preferably, shaping is carried out by placing the precursor mixture between two mold halves, after which it is cured and released from the mold to produce the moldings of interest. Other aspects of the invention relate to the polymeric precursor mixtures obtainable in accordance with the process of this invention, as well as to the moldings so produced. These aspects of the invention and several presently preferred embodiments will be described in more detail below.

More particularly, the invention in one aspect is directed to a novel crosslinkable polymeric precursor mixture that comprises a prepolymer containing crosslinkable groups, which prepolymer is obtained according to the present invention. The precursor mixture may optionally contain dead polymers, non-reactive diluents, and/or reactive plasticizers.

In another aspect, the invention relates to a novel process in which a crosslinkable polymeric precursor material is constituted, shaped into a desired geometry as a composition containing the polymer and a non-aqueous diluent, preferably by taking on the dimensions defined by the cavity between two or more mold portions, cured by a source of polymerizing energy, released from the mold, and immersed in an aqueous liquid such as water or physiological saline to substitute that liquid for the non-aqueous diluent, to produce the moldings of interest.

In a further aspect, the invention is directed to a method for preparing a molding which comprises the steps of, first, obtaining a precursor mixture containing a crosslinkable prepolymer. The crosslinkable prepolymer is obtained, according to the present invention, by the process of 1) mixing together i) one or more different types of monomers, ii) optionally, one or more non-reactive diluents, and iii) optionally, a solvent; 2) polymerizing the monomers to give a polymer; 3) adding one or more different types of functionalizing or derivatizing agents; 4) functionalizing or derivatizing the polymer; 5) optionally, adding one or more of the group consisting of reactive plasticizers and prepolymers dissimilar to the prepolymer synthesized in step 2); and 6) removing the solvent, residual impurities, unreacted functionalizing or derivatizing agents and byproducts, to give the precursor mixture containing a crosslinkable prepolymer. Optionally, a dead polymer, which is substantially unreactive, is also added to the precursor mixture at a desired point before removing the solvent.

The resulting crosslinkable prepolymer preparation is then introduced into a mold having a desired geometry; the mold is compressed so that the crosslinkable prepolymer preparation takes on the shape of the internal cavity of the mold; and the crosslinkable prepolymer preparation is exposed to a source of polymerizing energy; to give a cured molding.

Processes in accordance with this invention include both continuous processes and step-wise processes. Continuous processes include those in which a first stage is the polymerization of a monomer or combination of monomers in the presence of the non-aqueous diluent and optionally an additional solvent, while in succeeding stages the resulting polymer is functionalized to render the polymer capable of crosslinking. The solvent and impurities (such as unreacted monomer and functionalizing agent, residual initiator, polymerization catalyst, and any reaction by-products) in these continuous processes are removed by vacuum distillation, leaving only the crosslinkable polymer and the non-aqueous diluent in the appropriate proportions for casting and isometric exchange.

Step-wise processes permit the use of different solvents for each reaction as well as isolation and purification procedures between each reaction. Thus, unwanted components such as residual monomers, oligomers, and polymerization solvent can be removed after the polymerization step, and unreacted functionalizing agent, products of unwanted reactions, and solvent can be removed after the functionalization step. Also, the use of different solvents allows one to select solvents that are best suited for each stage.

The present invention provides an efficient means for producing novel polymeric precursor mixtures. The components and compositions of reaction media are selected to achieve the desired processing conditions to produce precursor mixtures. The components of precursor mixtures are chosen and the composition adjusted accordingly to achieve the desired processability of precursor mixtures, desired degree of reactivity (including effects on cure time and shrinkage), as well as the final physical, chemical, and optical properties of the moldings so produced.

An advantage of the process of this invention is the low shrinkage which can be realized upon cure. As will be discussed in more detail below, the overall concentration of reactive species is quite low in the polymeric precursor mixture. Another advantage is the speed with which the polymeric precursor mixture can be cured. Thus, the desired degree of reaction can be achieved very quickly using appropriate reaction initiators and a source of polymerizing energy.

In one embodiment of this invention, a process is designed to produce polymeric precursor mixtures for biomedical applications such as contact lenses which do not require purification steps upon curing and exhibit little net change in the volume after equilibration in physiological salt solutions.

In another embodiment of this invention, the precursor mixture is formulated as a semi-solid polymerizable composition. The use of a semi-solid precursor mixture has advantages over liquid precursor mixtures in that conventional liquid handling problems during mold filling, such as evaporative rings, inclusion of bubbles or voids, and Schlieren effects, can be avoided and the semi-solid precursor mixture does not require a gasket in the mold assembly to produce articles, such as ophthalmic lenses. Other advantages of the semi-solid precursor mixture of this invention will be discussed below.

In yet another embodiment of the present invention, the precursor mixture comprises a prepolymer, a dead polymer, and optionally, a reactive plasticizer and/or a non-reactive diluent. The component and composition of the precursor mixture are chosen accordingly to create a desired phase morphology which is locked-in by the rapid curing accomplished by the process of this invention.

With respect to the structure of crosslinked polymer network in the cured molding, the polymeric precursor mixtures of this invention provide crosslinked polymer networks which are distinct from those obtained by the conventional monomer-based casting processes in which moldings are produced by direct polymerization of monomer mixtures comprising multifunctional monomers (i.e., crosslinkers) and monofunctional monomers. Because multifunctional monomers are more reactive than monofunctional monomers, clustering of multifunctional monomers often occurs during direct polymerization of monomer mixtures to produce moldings. In the present invention, crosslinking bonds are formed at the functionalized sites on the prepolymer backbone. Because polymers can be functionalized uniformly, the crosslinking bonds in the polymer networks of this invention are more uniformly distributed than those of the conventional monomer-based casting systems. Thus, in yet another aspect, the invention also relates to the moldings produced from the polymeric precursor mixtures of this invention.

### DETAILED DESCRIPTION OF THE INVENTION AND PREFERRED EMBODIMENTS

The terms “a” and “an” as used herein and in the appended claims mean “one or more”.

The term “monomer” is used herein to include mixtures of two or more different monomers that polymerize to form a copolymer as well as single species that form a polymer consisting solely of a single repeating unit. The term “polymer” is used herein to include copolymers as well as polymers consisting solely of a single repeating unit.

In the present invention, polymerizable groups are incorporated into the precursor mixture through the prepolymer obtained by the continuous process of this invention, which comprises a polymerization step and a functionalization or derivatization step. The polymerization step first produces a polymer from a monomer mixture. The polymer so produced is then functionalized or derivatized with reactive groups to give the prepolymer, which is a functionalized crosslinkable polymer. Optionally, the precursor mixture also comprises reactive plasticizers and additional prepolymers which are dissimilar to the prepolymer synthesized in the present process.

The terms “functionalization” and “derivatization” are used herein interchangeably, and the term “functionalized with reactive groups” as used herein refers to the modification of a polymer to provide a plurality of reactive groups, particularly crosslinkable groups, on the backbone of the polymer. The term “crosslinkable” refers to polymers that are either devoid of crosslinking but capable of crosslinking under crosslinking conditions, or contain a limited degree of crosslinking and are capable of further crosslinking under appropriate conditions.

In addition, the polymeric precursor mixture may comprise non-reactive or substantially non-reactive diluents. The diluents may serve as bulking agents that do not contribute to the reactivity of the system, or they may function as compatibilizers in order to reduce phase separation tendencies of the other components in the mixture. While the diluents may play some role in the polymerization process, they will typically be assumed to be non-reactive, that is, they will not contribute significantly to the polymer chains or networks formed upon polymerization.

Oligomers or polymers possessing reactive groups, or being otherwise reactive, are at certain locations herein referred to as “prepolymers.” For the purposes of this disclosure, prepolymers shall furthermore refer to molecules having a formula weight greater than 300 or molecules which comprise more than one repeat unit linked together. Functionalized molecules having a formula weight below 300 and comprising only one repeat unit shall be referred to as “reactive plasticizers,” as discussed below. The prepolymers may possess terminal and/or pendant reactive functionalities, or they may simply be prone to grafting or other reactions in the presence of the polymerizing system used to constitute the polymeric precursor mixture. The polymeric precursor mixture of this invention contains at least one prepolymer which is obtained by functionalizing the polymer synthesized from a monomer mixture according to the process of this invention. The precursor mixture may also contain other prepolymers which are dissimilar to the prepolymer synthesized in the present process.

Alternatively, small molecule reactive species (i.e., monomers having a formula weight below about 300) may be optionally added to the polymeric precursor mixture in order to impart an added degree of reactivity and/or to achieve the desired semi-solid consistency and compatibility, in which case the small molecule reactive species may serve to plasticize the polymeric components. The small molecule species may otherwise serve as polymerization extenders, accelerators, or terminators during reaction. Regardless of their ultimate effect upon the polymeric precursor mixture and the subsequent polymerization reaction, such components shall hereinafter be referred to as “reactive plasticizers.”

The polymeric precursor mixture may furthermore comprise non-reactive or substantially non-reactive polymers, which shall hereinafter be referred to as “dead polymers.” The dead polymers may serve to add bulk to the polymeric precursor mixture without adding a substantial amount of reactive groups, or the dead polymers may be chosen to impart various chemical, physical, optical, and/or mechanical properties to the moldings of interest. The dead polymers may also serve as diluents for the polymerization step by decreasing the monomer concentration in the reaction medium. For semi-solid precursor mixtures, the dead polymers may further be used to impart a desired degree of semi-solid consistency to the precursor mixture.

Non-reactive, i.e., inert, diluents may be advantageously added to the polymeric precursor mixtures of the present invention in order to achieve compatibility of the mixture components, achieve the desired concentration of reactive functionalities, and to achieve the desired semi-solid consistency. Diluents are chosen based upon their compatibility with and plasticizing effects on the prepolymer, dead polymer, and reactive plasticizer constituents in the semi-solid precursor mixture. Typically, compatible mixtures are desired for the production of the moldings of interest, except where phase separation is either unavoidable or desired to achieve some desired material property in the final molding. For the production of ophthalmic lenses, clear systems upon cure are desirable, which can be easily achieved by selecting non-reactive diluents that are compatible with the prepolymers and dead polymers of the polymeric precursor mixture.

While the inert diluents are ostensibly unreactive in the polymerizing system of the polymeric precursor material, some minor degree of reaction may in fact occur, and such reaction will generally be acceptable and unavoidable. Diluents may also affect the polymerization reaction by acting as chain terminating agents (a known phenomenon when water is present in anionic polymerization systems, for example), thus slowing the rate of cure, the final degree of cure, or the molecular weight distribution ultimately obtained. Fortunately, because the polymeric systems of the present invention require little overall reaction from start to finish compared to predominantly monomeric systems, interference effects of the diluents will be greatly reduced, often to the point of having no measurable impact on the curing reaction. This greatly facilitates the choice of diluents that may be employed in the process of this invention, since reaction inhibition effects are less likely to arise.

By way of example, non-reactive diluents may include, but are not limited to: alcohols such as methanol, ethanol, propanol, butanol, pentanol, etc. and their methoxy and ethoxy ethers; glycols such as mono-, di-, tri-, tetra-, . . . polyethylene glycol and its mono- and di-methoxy and -ethoxy ethers, mono-, di-, tri-, tetra-, . . . polypropylene glycol and its mono- and di-methoxy and -ethoxy ethers, mono-, di-, tri-, tetra-, . . . polybutylene glycol and its mono- and di-methoxy and -ethoxy ethers, etc., mono-, di-, tri-, tetra-, . . . polyglycerol and its mono- and di-methoxy and -ethoxy ethers; alkoxylated glucosides such as the ethoxylated and propoxylated glucosides described in U.S. Pat. No. 5,684,058, and/or as sold under the “Glucam” trade name by Amerchol Corp.; ketones such as acetone, methyl ethyl ketone, methyl propyl ketone, methyl isobutyl ketone; esters such as ethyl acetate or isopropyl acetate; dimethyl sulfoxide, N-methylpyrrolidone, N,N-dimethyl formamide, N,N-dimethyl acetamide, cyclohexane, diacetone dialcohol, boric acid esters (such as with glycerol, sorbitol, or other polyhydroxy compounds, as disclosed in U.S. Pat. Nos. 4,495,313, 4,680,336, and 5,039,459), and the like.

The diluents employed for the production of contact lenses should ultimately be water-displaceable, although the diluents used in the production of moldings of interest may be first extracted with a solvent other than water, followed by water extraction in a second step, if desired.

“Over-the-counter” use of demulcents within ophthalmic compositions is regulated by the US Food & Drug Administration (FDA). For example, the Federal Register (21 CFR Part 349) entitled Ophthalmic Drug Products for Over-the-Counter Use: Final Monograph lists the accepted demulcents along with appropriate concentration ranges for each. Specifically, §349.12 lists the following approved “monograph” demulcents: (a) cellulose derivatives: (1) carboxymethyl cellulose sodium, (2) hydroxyethyl cellulose, (3) hydroxy propyl methyl cellulose, methylcellulose; (b) dextran 70; (c) gelatin; (d) polyols, liquid: (1) glycerin, (2) polyethylene glycol 300, (3) polyethylene glycol 400, (4) polysorbate 80, (5) propylene glycol; (e) polyvinyl alcohol; and (f) povidone (polyvinyl pyrrolidone). §349.30 further provides that in order to fall within the monograph, no more than three of the above-identified demulcents may be combined.

Diluents used in accordance with the present invention are preferably FDA-approved ophthalmic demulcents or mixtures of ophthalmic demulcents with water or saline solutions. In cases where water interferes with the polymerization process (which is less likely using polymeric precursor mixtures of the invention than in conventional polymerization schemes using liquid monomer precursors), pure demulcents or mixtures of demulcents with prepolymers, dead polymers, and/or reactive plasticizers may be employed. The concentration of the demulcents within the molding during cure may be much higher than the concentrations allowed by the FDA in cases where the moldings will be diluted or equilibrated in water or saline solution prior to use by the consumer, such as the case where contact lens moldings are placed into a package with an excess of saline solution for storage and shipping.

If semi-solid precursor mixtures are desired, the components and composition are also adjusted accordingly to achieve the desired semi-solid consistency. By “semi-solid” is meant that the mixture is substantially uncrosslinked, deformable, and fusible, yet can be handled as a discrete, free-standing entity during short operations such as insertion into a mold. For pure polymeric systems, the modulus of elasticity of a pure polymeric material is roughly constant with respect to molecular weight, above a certain value, known as the molecular weight cutoff. Thus, for the purpose of this disclosure, and in one aspect of the present invention, semi-solids will be defined as materials that, at fixed conditions such as temperature and pressure, exhibit a modulus below the constant modulus value seen for a given pure polymeric system at high molecular weights, i.e., above the molecular weight cutoff. The decrease in modulus used to achieve a semi-solid consistency may be achieved by incorporation of plasticizers (reactive or non-reactive diluents) into the semi-solid precursor mixture that serve to plasticize one or more of the prepolymer or dead polymer components. Alternatively, low molecular weight analogs below the molecular weight cutoff for a given prepolymer may be used in place of the fully polymerized version to achieve a reduction in modulus at the processing temperature. With these considerations in mind, preferred molecular weights are within the range of about 10,000 to about 1,000,000, more preferably from about 10,000 to about 300,000, and most preferably from about 50,000 to about 150,000. System parameters that can be varied to control the molecular weight are the amount of initiator used relative to the amount of monomer, the presence or lack of a chain transfer agent, the reaction temperature, the time during which the reaction is allowed to proceed, and the type and concentration of solvent used. The influence of each of these factors and the appropriate choice of each one to achieve a polymer of a particular molecular weight range will be readily apparent to those skilled in the art.

Using semi-solid precursor mixtures, the process of the present invention is advantageous with respect to the conventional molding techniques because the semi-solid precursor materials provide a small but finite resistance to flow such that the semi-solid material does not flow out of the mold upon its introduction, unlike liquid precursors used with static casting techniques. Yet, the semi-solid materials are compliant enough to be easily compressed and deformed to take on the desired mold cavity shape or surface features without undue resistance when two static compression molds are brought together. Furthermore, unlike typical thermoplastics, the semi-solid materials do not require an excessive or undesirable amount of heating and/or compressive force, typically seen with compression or injection molding techniques using conventional materials. Thus, the semi-solid materials of the present invention can be viewed as combining the easy deformability of liquids with the easy handling aspects of solids into a system that is reactive (but shows low shrinkage) and can be cured into a crosslinked entity upon cure.

With respect to a liquid precursor mixture, the advantage of the semi-solid precursor mixture is that conventional liquid handling problems during mold filling, such as evaporative rings, inclusion of bubbles or voids, and Schlieren effects, can be avoided with the use of the semi-solid precursor mixture. In addition, for the molding of ophthalmic lenses, the semi-solid precursor mixture does not require a gasket in the mold assembly.

The molding process, which makes use of semi-solid precursor mixtures, also has an advantage over the previous process which uses partially cured gel preforms disclosed by U.S. Pat. No. 4,260,564 for the production of ophthalmic lenses. In the partially cured gel-based molding process, a liquid monomer mixture in a mold assembly is first partially cured to form a gel, which takes a geometry close to the shape of the final object of interest. This partially cured gelled preform is then transferred to another mold assembly where the preform is molded further to a desired shape and fully cured. Because gels are not fusible, defects such as scratches on the surface of partially cured gel preforms and internal stress introduced during the molding operation remain in the cured articles produced from partially cured gel preforms. The semi-solid precursor mixtures of this invention overcome these problems because semi-solids are substantially uncrosslinked, malleable, and fusible.

Another advantage of the semi-solid precursor mixture is that when free radical-based polymerization schemes are used to cure the semi-solid precursor mixture, inhibition effects due to oxygen are reduced. While not wishing to be bound by theory, it is believed that this effect results from a low oxygen mobility within the semi-solid material prior to and during cure, as compared to conventional liquid-based casting systems. Thus, complex and costly schemes (both molding of the molds as well as molding of the final part, as described in U.S. Pat. Nos. 5,922,249 and 5,753,150, for instance) currently used to exclude oxygen from molding processes can be eliminated, and reaction will still proceed to completion in a timely fashion as mentioned above.

In the present invention, which preferably makes use of semi-solid precursor mixtures, reaction proceeds quickly because the reaction is a crosslinking reaction and the precursor polymer contains only a small number of crosslinking sites, and inhibition effects due to oxygen are reduced in the semi-solid precursor mixture. By “quick curing time” is meant that the polymeric precursor mixtures of the present invention cure faster than a liquid composition in cases where the liquid formulation possesses the same type of reactive functional groups and the other curing parameters, such as energy intensity and part geometry, are constant. Typically, about 10 minutes or less of exposure to a source of polymerizing energy is needed in order to achieve the desired degree of cure when photoinitiated systems comprising the semi-solid precursors are used. More preferably, the curing occurs in less than about 100 seconds of exposure, and even more preferably in less than about 10 seconds. Most preferably, the curing occurs in less than about 2 seconds of exposure to a source of polymerizing energy. Such rapid curing times can be more easily realized for thin moldings such as contact lenses.

Because the semi-solid material can be cured rapidly and contains a relatively small amount of monomers, a great processing advantage can be realized in the recycling or reuse of lens molds after each molding cycle. When released from a mold upon cure, the semi-solid precursor mixture leaves much less residual monomers on the mold surface than the liquid precursor mixture. Thus, one embodiment of the present invention is a process in which contact and ophthalmic lens molds are reused for more than one molding cycle, with optional cleaning steps in between uses, in accordance with the use of semi-solid precursor mixtures as discussed herein.

The polymeric precursor mixtures disclosed by the present invention may be advantageously utilized to produce polymerized and/or crosslinked moldings. Therefore, in yet another aspect, the present invention relates to moldings produced from curing a polymeric precursor mixture. For the purpose of producing contact lenses or intraocular lenses, the compositions of the fully cured moldings are chosen such that they become hydrogels when placed into essentially aqueous solutions; that is, the moldings will absorb about 10 to 90 weight percent water upon establishing equilibrium in a pure aqueous environment, but will not dissolve in the aqueous solution. Said moldings shall be hereinafter referred to as “hydrogels.”

The polymeric precursor mixtures of this invention may also be advantageously utilized to produce homogeneous hydrogels in which the crosslinking bonds are uniformly or substantially uniformly distributed. As stated previously, in the prior art gels synthesized by direct polymerization of monomer mixtures, crosslinking bonds may not be uniformly distributed because of the clustering of multifunctional monomers.

For the purposes of this disclosure, essentially aqueous solutions shall include solutions containing water as the majority component, and in particular aqueous salt solutions. It is understood that certain physiological salt solutions, i.e., saline solutions, may be preferably used to equilibrate or store the moldings in place of pure water. In particular, preferred aqueous salt solutions have an osmolarity of from about 200 to 450 milli-osmolarity in one liter; more preferred solutions are from about 250 to 350 milliosmol/L. The aqueous salt solutions are advantageously solutions of physiologically acceptable salts such as phosphate salts, which are well-known in the field of contact lens care. Such solutions may further comprise isotonicizing agents such as sodium chloride, which are again well known in the field of contact lens care. Such solutions shall hereinafter be referred to generally as saline solutions, with no preference given to salt concentrations and compositions outside of the currently known art in the field of contact lens care.

The moldings of the present invention may be advantageously formed into contact lenses or intraocular lenses that exhibit “minimal expansion or contraction”; that is, they exhibit little or no expansion or contraction of the hydrogel upon placement into saline solution. This may be accomplished by adjusting the amount of diluent present such that no net volume change of the hydrogel occurs when the molding is equilibrated in a saline environment. This goal can be readily achieved by using saline as the sole diluent so long as it is incorporated at the same concentration in the semi-solid precursor mixture as its equilibrium content after hydrogel formation, which can be readily determined by simple trial and error experimentation. Should one prefer the use of other diluents either with or without the presence of saline in the semi-solid precursor mixture, then the diluent concentration leading to no net volume change of the hydrogel when equilibrated with saline may not be the same as the equilibrium saline concentration but, again, can again be readily ascertained by simple trial and error experimentation.

“Extraction” is the process by which unwanted or undesirable species (usually small molecule impurities, polymerization by-products, unpolymerized or partially polymerized monomer, etc., sometimes referred to as extractables) are removed from a cured hydrogel prior to its intended use. By “prior to its intended use” is meant, for example in the case of a contact lens, prior to insertion into the eye. Extraction steps are a required feature of prior art processes used to make contact lenses, for example (see U.S. Pat. Nos. 3,408,429 and 4,347,198), which add complications, processing time, and expense to the molding production process.

An advantage of the present invention is that moldings can be produced that do not require an extraction step, or require only a minimal extraction step, once the polymerization step is complete. By “minimal extraction step” and “minimum extraction” are meant that the amount of extractables is sufficiently low and/or the extractable composition is sufficiently non-toxic that any required extraction may be accommodated by the fluid within the container in which the lens is packaged for shipment to the consumer. The phrases “minimal extraction step” and “minimum extraction” may furthermore comprise any washing or rinsing that occurs as a part of any aspect of the demolding operation, as well as any handling steps. For example, liquid jets are sometimes used to facilitate movement of the lens from one container to another, demolding from one or more of the lens molds, etc., said jets generally comprising focused water or saline solution streams. During these processes, some extraction or rinsing away of any extractable lens materials may be reasonably expected to occur, but in any case shall be deemed to fall under the class of materials and processes requiring a minimal extraction step, as presented in this disclosure.

As an example, in one embodiment of the present invention, the polymeric precursor mixture comprises 30-70 weight % of a prepolymer, a photoinitiator, and a non-reactive diluent that is selected from the group consisting of water and FDA-approved ophthalmic demulcents. Upon curing, the molding may be placed directly into a contact lens packaging container containing about 3.5 mL of saline fluid for storage, with the aid of one or more liquid jets to aid in the demolding process and to further facilitate lens handling without mechanical contact (see for example, U.S. Pat. No. 5,836,323), whereupon the molding will equilibrate with the surrounding fluid in the package. Since the molding volume of a contact lens (e.g., about 0.050 mL) is small relative to the fluid volume in the lens package, the demulcent concentration will be at least about 1 wt % or lower in both the solution and the lens after equilibration, which concentration is acceptable for direct application to the eye by the consumer. Thus, while from a strict viewpoint an extraction step is used in this embodiment, the extraction step is reduced to a minimal extraction step—that which occurs inherently during the demolding, handling and packaging processes. The fact that no separate extraction step is used per se represents a significant advantage of the present invention disclosed herein.

In one embodiment, the present invention relates to prepolymers that are not substantially water-soluble. By “water-soluble” is meant that the prepolymers are capable of being dissolved in water or saline solutions over the entire concentration range of about 1-10 wt % prepolymer under ambient conditions, or more preferably about 1-70% prepolymer in water or saline solutions. Thus, for purposes of this disclosure, “water-insoluble” or “non water-soluble” prepolymers shall be those which do not completely dissolve in water over the concentration range of about 1-10% in water at ambient conditions. In a preferred embodiment, hydrogels made from prepolymers that are water-insoluble may be water-swellable such that they are capable of producing a homogeneous mixture upon absorbing from 10 to 90% water. Generally, such water-swellable hydrogels will exhibit a maximum water absorption (i.e., equilibrium water content) that is a function of the chemical composition of the polymers making up the hydrogel, as well as the hydrogel crosslink density. Preferred hydrogels in accordance with this invention are those exhibiting an equilibrium water content of from about 20 to 80 wt % water in a water or saline solution. When crosslinked, such water-insoluble but water-swellable materials desirably produce clear hydrogels, which are useful products of the present invention.

In a preferred embodiment of the invention, a homogenous mixture of one or more prepolymers and one or more non-reactive diluents is constituted that is substantially free from monomeric, oligomeric, or polymeric compounds used in (and by-products formed during) the preparation of the prepolymer, as well as being free of any other unwanted constituents such as impurities or diluents that are not ophthalmic demulcents. By “substantially free” is meant herein that the concentration of the undesirable constituents in the semi-solid precursor mixture is preferably less than 0.001% by weight, and more preferably less than 0.0001% (1 ppm). The acceptable concentration range for such undesirable constituents will ultimately be determined by the intended use of the final product. This mixture preferably contains only diluents that are water or are recognized by the FDA as acceptable ophthalmic demulcents in limited concentrations in the eye. The mixture is furthermore constituted so as to not contain any additional co-monomers or reactive plasticizers. In this manner a polymeric precursor mixture is constituted which contains no or essentially no unwanted constituents, and thus the molding produced therefrom contains no or essentially no unwanted constituents. Moldings are therefore produced which do not require the use of a separate extraction step, aside from the extraction/equilibration process which occurs within the packaging container and during demolding and intermediate handling steps after the cured molding has been produced.

In another preferred embodiment of the present invention, the diluent composition and concentration in the polymeric precursor mixture is chosen such that upon curing and subsequent equilibration in saline solution, little net change in hydrogel volume occurs. Preferably, hydrogel volume changes by no more than 10% upon equilibration in a physiologically acceptable saline solution. More preferably, the hydrogel volume changes by less than 5%, and even more preferably by less than 2%. Most preferably, the hydrogel volume changes by less than 1% upon equilibration in saline after molding, cure and demolding.

Minimal hydrogel volume changes upon equilibration in saline are made possible by the novel polymeric precursor mixtures of the present invention because the polymeric polymerizable compositions (1) exhibit low shrinkage upon cure, and (2) can be formulated to contain the amount of diluent necessary to compensate for the equilibrium content of water.

In yet another preferred embodiment, the diluent concentration is adjusted such that a fixed amount of hydrogel swelling occurs upon equilibration in water. This is sometimes helpful to aid in the demolding process, and yet the hydrogel volume change can be accommodated by an appropriate mold design which takes into account a small but fixed amount of swelling of the finished molding.

In a presently preferred embodiment, the polymeric precursor mixture comprises a water-insoluble but water-swellable prepolymer that is a functionalized copolymer of polyhydroxyethyl methacrylate (pH EMA). The copolymer can comprise methacrylic acid, acrylic acid, n-vinyl pyrrolidone, dimethyl acrylamide, vinyl alcohol, and other monomers along with HEMA. A presently preferred embodiment comprises pHEMA copolymerized with approximately 2% methacrylic acid (MAA). In addition, polymerizable additives such as reactive dyes and reactive UV absorbers can also be copolymerized with the monomers. This copolymer is subsequently functionalized with methacrylate groups or acrylate groups to create a reactive prepolymer suitable for the production of ophthalmic moldings useful as contact lenses. The reactive groups are covalently attached to the polymer backbone through the hydroxyl groups of HEMA. The pHEMA-co-MAA copolymer is diluted with the polyethylene glycol which has an average molecular weight of 400 (PEG 400) at a concentration of about 50 wt % and a photoinitiator such as IRGACURE® 184, DAROCUR® 1173, and/or IRGACURE® 1750 is added at a concentration of approximately 1 weight %.

In one preferred embodiment of this invention, the polymeric precursor mixture containing pHEMA-co-MAA copolymer is obtained by the method which comprises the steps of:
mixing together i) one or more different types of monomers and a thermal initiator, ii) at least one non-reactive low-volatility diluent in an amount such that after molding it can provide an isometric exchange with saline solution, and iii) a volatile non-aqueous solvent in an amount to prevent an insoluble gel from forming during the ensuing polymerization and functionalization steps;
polymerizing the monomers to give a polymer;
adding one or more different types of functionalizing or derivatizing agents;
functionalizing or derivatizing the polymer and adding a photoinitiator; and
evaporating off the solvent, residual impurities, unreacted functionalizing or derivatizing agents and byproducts, to give the polymeric precursor mixture containing the non-reactive diluent.

The advantage of the process of this invention is that after the polymerization step, it is not necessary to recover and purify polymers and blend polymers with non-reactive diluents because the polymers are synthesized and functionalized continuously in the presence of the non-reactive diluents which constitute the final precursor mixtures. The use of volatile solvent is advantageous for producing the polymeric precursor mixture in which a polymer is synthesized from a monomer, such as HEMA, which contains a multifunctional monomer as impurity. The presence of the volatile solvent prevents the formation of an insoluble gel even when a small amount of multi-functional monomers exist in the reaction medium. And, its volatile character allows it to be easily removed without excessive additional processing.

The material obtained in this manner is a homogeneous precursor mixture which is optically clear. Small portions of the precursor mixture can be removed from the bulk mass and inserted into a mold cavity as a discrete quantity. Upon closing the mold, the precursor deforms and takes the shape of the internal cavity defined by the mold halves. When the sample is irradiated with a source of polymerizing energy such as heat or UV light, the precursor mixture cures into a water-swellable crosslinked gel that can subsequently be demolded and placed into saline solution for equilibration. The resulting hydrogel can be designed to absorb approximately 30-70% water at equilibrium, while exhibiting mechanical properties such as elongation-to-break and modulus similar to commercially available contact lens materials. Thus, the molding so produced is useful as an ophthalmic lens, especially a contact or intraocular lens, said lens being produced with a polymeric precursor material that exhibits low shrinkage during a rapid curing step, and said lens requiring no separate extraction step aside from the equilibration step in the package.

Another preferred embodiment uses silicone-based monomers and hydrophilic silicones, which are copolymers of a hydrophilic component and a silicone component exhibiting high oxygen permeability, as the starting monomers, dead polymers, or when possessing additional functional groups, as prepolymers or reactive plasticizers. These materials are particularly useful for contact lenses. Suitable silicone-based monomers and prepolymers for producing the polymeric precursor mixtures of the present invention are disclosed in U.S. Pat. Nos. 4,136,250, 4,153,641, 4,740,533, 5,010,141, 5,034,461, 5,057,578, 5,070,215, 5,314,960, 5,336,797, 5,356,797, 5,371,147, 5,387,632, 5,451,617, 5,486,579, 5,789,461, 5,807,944, 5,962,548, 5,998,498, 6,020,445, and 6,031,059, as well as PCT Appl. Nos. WO094/15980, WO097/22019, WO099/60048, WO099/60029, and WO001/02881, and European Pat. Appl. Nos. EP00940447, EP00940693, EP00989418, and EP00990668.

Another preferred embodiment uses perfluoroalkyl polyethers, which are fluorinated to give good oxygen permeability and inertness, yet exhibit an acceptable degree of hydrophilicity due to the polymer backbone structure and/or hydrophilic pendant groups. Such materials may be readily incorporated into the polymeric precursor mixtures of the present invention as the dead polymers, or when possessing additional functional groups, as prepolymers or reactive plasticizers. For examples of such materials, see U.S. Pat. Nos. 5,965,631, 5,973,089, 6,060,530, 6,160,030, and 6,225,367.

In principle, mixtures of any monomers may be used in the polymerization step of this invention, provided that the synthesized polymers contain functionalizable groups. By “functionalizable groups” is meant the groups which are capable of undergoing functionalization or derivatization reactions to introduce functional groups on the polymer backbone. The monomer may be acrylate, methacrylate, acrylic anhydride, acrylamide, vinyl, vinyl ether, vinyl ester, vinyl halide, vinyl silane, vinyl siloxane, (meth)acrylated silicones, vinyl heterocycles, diene, allyl and the like. Other less known but polymerizable systems can be employed, such as epoxies (with hardeners) and urethanes (reaction between isocyanates and alcohols).

Polymerization mechanisms that may be employed by the present invention purely by way of example include free-radical polymerization, cationic or anionic polymerization, cycloaddition, Diels-Alder reactions, ring-opening-metathesis polymerization, and vulcanization. Polymers may be homopolymers or copolymers of linear, branched, dendritic, or lightly crosslinked structures.

To demonstrate the great diversity of monomers that can be used in the present invention, we will name only a few from a list of hundreds to thousands of commercially available compounds. For example, mono-functional monomers include (meth)acrylates such as methyl (meth)acrylate and 2-hydroxyethyl methacrylate (HEMA), vinyl lactams such as N-vinyl-2-pyrrolidone, (meth)acrylamide and its analogues such as N-isopropyl acrylamide, vinyl acrylic acids such as (meth)acrylic acid, vinyl acetate, vinyl benzoate, styrene, α-methyl styrene, maleic anhydride, and acrylonitrile. Note, notations such as “(meth)acrylate” or “(meth)acrylamide” are used to denote optional methyl substitutions.

Other mono-functional (meth)acrylic monomers include: ethyl (meth)acrylate; propyl (meth)acrylate; butyl (meth)acrylate; octyl (meth)acrylate; isodecyl (meth)acrylate; hexadecyl (meth)acrylate; stearyl (meth)acrylate; propyl (meth)acrylate; pentyl (meth)acrylate; tetrahydrofurfuryl (meth)acrylate; caprolactone (meth)acrylate; benzyl (meth)acrylate; phenyl (meth)acrylate; 2-phenylphenyl (meth)acrylate; phenoxyethyl (meth)acrylate; 1-naphthyloxyethyl (meth)acrylate; cyclohexyl (meth)acrylate; isobornyl (meth)acrylate; norbornyl (meth)acrylate; adamantyl (meth)acrylate; tricyclo[5.2.1.0^{2,6}]-decan-8-yl (meth)acrylate; ethylene glycol phenyl ether (meth)acrylate; 3-hydroxy-2-naphtyl (meth)acrylate; 2-hydroxyethyl acrylate (HEA); 2-hydroxybutyl (meth)acrylate; 2-hydroxypropyl (meth)acrylate; 3-phenoxy-2-hydroxy-phenoxyethyl (meth)acrylate; 3-hydroxypropyl (meth)acrylate; 4-hydroxybutyl (meth)acrylate; 4-t-butyl-2-hydroxycyclohexyl (meth)acrylate; 2-ethylhexyl (meth)acrylate; 2-ethoxyethyl (meth)acrylate; ethoxyethyl (meth)acrylate; methoxyethyl (meth)acrylate; methoxy triethyleneglycol (meth)acrylate; hydroxytrimeththylene (meth)acrylate; dimethylamino ethyl(meth)acrylate; glycidyl (meth)acrylate; 2-phosphatoethyl (meth)acrylate; mono-, di-, tri-, tetra-, penta-, . . . polyethylenglycol mono(meth)acrylate; 1,2-butylene (meth)acrylate; 1,3 butylene (meth)acrylate; 1,4-butylene (meth)acrylate; mono-, di-, tri-, tetra-, . . . polypropylene glycol mono(meth)acrylate; glyceryl (meth)acrylate; gylcerine mono(meth)acrylate; 2-ethyl-2-(hydroxy-methyl)-1,3-propanediol trimethyl(meth)acrylate.

Other types of monomers also include: methylacrylamide; N,N-dimethyl(meth)acrylamide; diacetone (meth)acrylamide; N-methyl(meth)acrylamide; N,N-dimethyl-diacetone(meth)acrylamide; N-(1,1-dimethyl-3-oxobutyl)(meth)acrylamide; N-(formylmethyl)(meth)acrylamide; 4- and 2-methyl-5-vinylpyridine; N-(3-(meth)acrylamidopropyl)-N,N-dimethylamine; N-(3-(meth)acrylamidopropyl)-N,N,N-trimethylamine; N-(3-(meth)acrylamido-3-methylbutyl)-N,N-dimethylamine; 1-vinyl-, and 2-methyl-1-vinlymidazole; N-vinyl imidazole; N-vinyl succinimide; N-vinyl diglycolylimide; N-vinyl glutarimide; N-vinyl-3-morpholinone; N-vinyl-5-methyl-3-morpholinone; dimethyldiphenyl methylvinyl siloxane; α-(dimethylvinylsilyl)-ω-[(dimethylvinyl-silyl)oxy]-dimethyl diphenyl methylvinyl siloxane; vinyl propionate; vinyl alcohol; 2-((meth)acryloyloxy)ethyl vinyl carbonate; vinyl[3-[3,3,3-trimethyl-1,1-bis(trimethylsiloxy)disiloxany]propyl]carbonate; 4,4′-(tetrapentacontmethylheptacosasiloxanylene)di-1-butanol; N-carboxy-β-alanine N-vinyl ester; 2-methacryloylethyl phosphorylcholine; methacryloxyethyl vinyl urea; vinyltoluene; 1-vinylnaphthalene; metallic salts of (meth)acrylic acid; monomers containing quarternary ammonium salts; and the like.

The notation “mono-, di-, tri-, tetra-, . . . poly-” is used to denote monomers, dimers, trimers, tetramers, etc., up to and including polymers of the given repeat unit.

When high-refractive index materials are desired, monomers may be chosen accordingly to have high refractive indices. Examples of such monomers, in addition to those mentioned above, include brominated or chlorinated phenyl (meth)acrylates (e.g., pentabromo methacrylate, tribromo acrylate, etc.), brominated or chlorinated naphthyl or biphenyl (meth)acrylates, tribromophenoxyethyl (meth)acrylate, tribromophenyldi(oxyethyl) (meth)acrylate, tribromoneopentyl (meth)acrylate, tribromobenzyl (meth)acrylate, bromoethyl (meth)acrylate, brominated or chlorinated styrenes, vinyl naphthylene, vinyl biphenyl, vinyl phenol, vinyl carbazole, vinyl bromide or chloride, vinylidene bromide or chloride, bromophenyl isocyanate, phenylthiol (meth)acrylate, 4-chlorophenylthiol (meth)acrylate, penta-chlorophenylthiol (meth)acrylate, naphthylthiol (meth)acrylate, and the like. Increasing the aromatic, sulfur and/or halogen content of monomers is a well-known technique for achieving high-refractive index properties.

The process of the present invention comprises the polymerization and functionalization or derivatization steps to produce prepolymers. The components of monomer mixtures are chosen such that the resulting polymers contain functionalizable or derivatizable groups. In the functionalization or derivatization step, functionalizing agents are reacted with polymers to produce prepolymers by introducing reactive groups on the polymer backbone. By “functionalizing agents” is meant molecules which have groups reactive to the polymers and, upon reacting with polymers, introduce reactive groups on the polymer backbone and thereby render the polymer capable of crosslinking. The functionalization reaction may be carried out as a single step using a suitable functionalizing agent. Alternatively, the functionalizable group on the polymer backbone is transferred further to another type of functionalizable group by reacting with a molecule, which is then reacted with the functionalizing agent. The examples of functionalizable groups include, but are not limited to: hydroxyls, amines, carboxylates, thiols (disulfides), anhydrides, urethanes, and epoxides.

For functionalizing the polymers containing hydroxyls, functionalizing agents comprise the hydroxyl-reactive groups such as, but not limited to, epoxides and oxiranes, carbonyl diimidazole, oxidation with periodate, enzymatic oxidation, acid halides, alkyl halides, isocyanates, halohydrins, and anhydrides. For functionalizing the polymers containing amine groups, functionalizing agents comprise the amine-reactive groups such as isothiocyanates, isocyanates, acyl azides, N-hydroxysuccinimide esters, sulfonyl chlorides, ketones, aldehydes and glyoxals, epoxides and oxiranes, carbonates, arylating agents, imidoesters, carbodiimides, anhydrides, and halohydrins. For functionalizing the polymers containing thiol groups, examples of thio-reactive chemical reactions are haloacetyl and alkyl halide derivatives, maleimides, aziridines, acryloyl derivatives, arylating agents, and thioldisulfide exchange regents (such as pyridyl disulfides, disulfide reductants, and 5-thio-2-nitrobenzoic acid).

In a presently preferred embodiment, the reactive groups on the prepolymer backbone are acrylate, methacrylate, acrylamide, and/or vinyl ether moieties which are found to give convenient, fast-curing UV-triggered systems.

To produce prepolymers for high-refractive index ophthalmic lenses, one preferred embodiment uses the monomers that contain both halogen atoms and functionalizable groups such as hydroxyls. Examples include, but are not limited to: 3-(2,4,6-tribromo-3-methylphenoxy)-2-hydroxypropyl (meth)acrylate; 3-(2,4-dibromo-3-methylphenoxy)-2-hydroxypropyl (meth)acrylate; 3-(3-methyl-5-bromophenoxy)-2-hydroxypropyl (meth)acrylate; 2-(4-hydroxyethoxy-3,5-dibromophenyl)-2-(4-acryloxyethoxy-3,5-dibromophenyl)propane; 2-(4-hydroxyethoxy-3,5-dibromophenyl)-2-(4-acryloxy-3,5-dibromophenyl)propane; and 2-(4-hydroxydiethoxy-3,5-dibromophenyl)-2-(4-methacryloxydiethoxy-3,5-dibromophenyl)propane.

Monomer mixtures may also contain multifunctional monomers. In that event, the compositions and components of non-reactive diluents and/or solvents are chosen accordingly to prevent insoluble gels from forming during the polymerization and functionalization steps.

Optionally, polymerizable additives such as reactive (i.e., polymerizable) dyes and reactive (i.e., polymerizable) UV absorbers may be included in the monomer mixtures. In certain preferred embodiments of this invention, prepolymers are synthesized from monomer mixtures which also comprise reactive dyes and reactive UV absorbers for the production of tinted UV absorbable contact lenses. One such monomer mixture includes 2-hydroxyethylmethacrylate, methacrylic acid, and the reactive dye known as “blue hydroxyethylmethacrylate” or “blue HEMA.” Another such monomer mixture includes these three components plus the reactive UV absorber known as “Norbloc.” The chemical name for blue HEMA is 2-methyl-acrylic acid 2-{4-[5-(4-amino-9,10-dioxo-3-sulfo-4a,9,9a, 10-tetrahydroanthracen-1-ylamino)-2-sulfophenylamino]-6-chloro-[1,3,5]triazin-2-yloxy}-ethyl ester, and the chemical formula is: 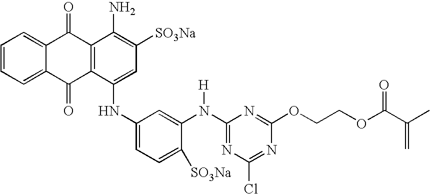
The chemical name for Norbloc is 2-methyl-acrylic acid 2-(3-benzotriazol-2-yl-4-hydroxyphenyl)-ethyl ester, and the chemical formula is:

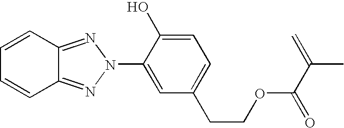

One group of preferred prepolymers includes the polymers or copolymers comprising sulfoxide, sulfide, and/or sulfone groups within or pendant to the polymer backbone structure that have been functionalized with additional reactive groups. Gels resulting from sulfoxide-, sulfide-, and/or sulfone-containing monomers (without the added reactive groups after initial polymerization) have shown reduced protein adsorption in conventional contact lens formulations (see, U.S. Pat. No. 6,107,365 and PCT International Publication No. WO00/02937). These monomers are readily incorporated into the polymeric precursor mixtures of the present invention as starting monomers for prepolymers and/or through dead polymers.

Another group of preferred prepolymers consists the prepolymers containing one or more pendant or terminal hydroxy groups, some portion of which have been functionalized with reactive groups capable of undergoing free-radical based polymerization. Examples of such prepolymers include functionalized versions of polyhydroxyethyl (meth)acrylate, polyhydroxypropyl (meth)acrylate, polyethylene glycol, cellulose, dextran, glucose, sucrose, polyvinyl alcohol, polyethylene-co-vinyl alcohol, mono-, di-, tri-, tetra-, . . . polybisphenol A, and adducts of ε-caprolactone with C₂₋₆ alkane diols and triols. Copolymers, ethoxylated, and propoxylated versions of the above-mentioned polymers are also preferred prepolymers (see, for example PCT International Publication No. WO098/37441).

Particularly preferred prepolymers are methacrylate- or acrylate-functionalized poly(hydroxyethyl methacrylate-co-methacrylic acid) copolymers. Most preferred prepolymers are copolymers of hydroxyethyl methacrylate (HEMA) with about 0-2% methacrylic acid (MAA), where about 0.2-5% of the pendant hydroxyl groups of the copolymer have been functionalized with methacrylate groups to give a reactive prepolymer suitable for the polymeric precursor mixtures and the process of this invention. A more preferable degree of methacrylate functionalization is about 0.5-2% of the hydroxyl groups. For functionalizing the hydroxyls of HEMA, examples of functionalizing agents include methacrylic anhydride and glycidyl methacrylate.

In another preferred embodiment, the prepolymers are methacrylate- or acrylate-functionalized pHEMA-co-MAA copolymers copolymerized with reactive dyes and reactive UV absorbers consisting of about 0-2% MAA, where about 0.2-5% of the pendant hydroxyl groups of the copolymer have been functionalized with methacrylate or acrylate groups to give a reactive prepolymer suitable for the polymeric precursor mixtures and the process of this invention. More preferably, degree of methacrylate functionalization is about 0.5-2% of the hydroxyl groups and the functional group is methacrylate.

When high-refractive index prepolymers are an important consideration, as stated previously, increasing the aromatic content, the halogen content (especially bromine), and/or the sulfur content are generally effective means well known in the art for increasing the refractive index of a polymeric material.

In the present invention, the polymeric precursor mixtures may also contain reactive plasticizers. Reactive plasticizers are added to the reaction medium upon completing the functionalization or derivatization reaction. During the molding and curing operation, the presence of reactive plasticizers may improve the processability by lowering the softening temperatures of precursor mixtures. With respect to the lowering of softening temperature, reactive plasticizers are particularly useful for the precursor mixtures for ophthalmic lenses that do not comprise non-reactive diluents but contain temperature-sensitive high-refractive index polymers. Thus, in one embodiment of this invention, the polymeric precursor mixture comprises a high-refractive index prepolymer and a reactive plasticizer. More preferably, the precursor mixtures are semi-solids.

The reactive plasticizers may also be used to accelerate the crosslinking reaction of prepolymers and/or to increase the crosslinking density of cured moldings. The prepolymers which by themselves do not form crosslinked gels may be crosslinked to form insoluble hydrogels in the presence of a small amount of reactive plasticizers. For some biomedical applications, the residual reactive groups in the cured moldings may have to be minimized because of the decreased biocompatibility due to the presence of reactive groups. Thus, in another embodiment of the present invention, the polymeric precursor mixture comprises a prepolymer and a reactive plasticizer, and optionally a non-reactive diluent, in which the precursor mixture does not cure to form an insoluble gel in the absence of the reactive plasticizer.

When optically clear materials are desired in phase-separated systems, the mixture components (i.e., the prepolymers, dead polymers, the impact modifiers, non-reactive diluents, and/or the reactive plasticizers) may be chosen to produce the same refractive index between the phases (iso-refractive) such that light scattering is reduced. When iso-refractive components are not available, the diluents and reactive plasticizers may nonetheless act as compatibilizers to help reduce the domain size between two immiscible polymers to below the wavelength of light, thus producing an optically clear polymer mixture that would otherwise have been opaque. The presence of reactive plasticizers may also in some cases improve the adhesion between the impact modifier and the dead polymer, improving the resultant mixture properties.

The reactive plasticizers can be used singly or in mixtures. The reactive functional group may be, but is not limited to, acrylate, methacrylate, acrylic anhydride, acrylamide, vinyl, vinyl ether, vinyl ester, vinyl halide, vinyl silane, vinyl siloxane, (meth)acrylated silicones, vinyl heterocycles, diene, allyl and the like. Other less known but polymerizable functional groups can be employed, such as epoxies (with hardeners) and urethanes (reaction between isocyanates and alcohols). In principle, any monomers may be used as reactive plasticizers in accordance with the present invention, although preference is given to those which exist as liquids at ambient temperatures or slightly above, and which polymerize readily and rapidly with the application of a source of polymerizing energy such as light or heat in the presence of a suitable initiator.

Reactive monomers, oligomers, and crosslinkers that contain acrylate or methacrylate functional groups are well known and commercially available from Sartomer, Radcure and Henkel. Similarly, vinyl ethers are commercially available from Allied Signal/Morflex. Radcure also supplies UV curable cycloaliphatic epoxy resins. Vinyl, diene, and allyl compounds are available from a large number of chemical suppliers. Examples of reactive plasticizers are discussed, for example, in PCT Publication No. WO 00/55653.

When high-refractive index materials are desired, the reactive plasticizers may be chosen accordingly to have high refractive indices. As stated previously, increasing the aromatic, sulfur, and/or halogen content of the reactive plasticizers is a well-known technique for achieving high-refractive index properties of polymeric materials.

In a presently preferred embodiment, reactive plasticizers containing acrylate, methacrylate, acrylamide, and/or vinyl ether moieties are found to give convenient, fast-curing UV-triggered systems.

The reactive plasticizers can be mixtures themselves, composed of mono-functional, bi-functional, tri-functional or other multi-functional entities. For example, incorporating a mixture of monofunctional and multi-functional reactive plasticizers will, upon polymerization, lead to a reactive plasticizer polymer network in which the reactive plasticizer polymer chains are crosslinked to each other (i.e., a semi-IPN). During polymerization, the growing reactive plasticizer polymer chains may react with the prepolymer to create an IPN. The reactive plasticizer and prepolymer may also graft to or react with the dead polymer, creating a type of IPN, even if no unsaturated or other apparently reactive entities are present within the dead polymer chains. Thus, the prepolymer and dead polymer chains may act as crosslinking entities during cure, resulting in the formation of a crosslinked reactive plasticizer polymer network even when only monofunctional reactive plasticizers are present in the mixture with prepolymers and/or dead polymers.

In addition to prepolymers, systems of interest to the present application may comprise one or more substantially unreactive polymeric components, i.e., dead polymers. The dead polymers may serve to add bulk to the polymeric precursor mixture without adding a substantial amount of reactive groups, or the dead polymers may be chosen to impart various chemical, physical, optical, and/or mechanical properties to the moldings of interest.

The dead polymers may be linear, branched, or crosslinked. The simplest of such systems might be considered to be ordinary homopolymers. In such cases, the dead polymer is generally chosen to be compatible with the prepolymer in the precursor mixture of interest, at least at some desired processing conditions of temperature and pressure. “Compatibility” refers to the thermodynamic state where the mixture containing the dead polymer and prepolymer forms a homogeneous mixture. In practice it has been found that molecular segments with structural similarity promote mutual dissolution. Hence, aromatic moieties on the dead polymer generally promote compatibility with aromatic prepolymers, and vice versa. Hydrophilicity and hydrophobicity are additional considerations in choosing the pair of dead polymer and prepolymer for the polymeric precursor mixture. Compatibility may generally be assumed in systems that appear clear or transparent upon mixing, although for the purposes of this invention, compatibility is not required, but is merely preferred, especially when transparent objects are to be produced.

Even when only partial compatibility is observed at room temperature, the mixture often becomes uniform at a slightly increased temperature; i.e., many systems become clear at slightly elevated temperatures. Such temperatures may be slightly above ambient temperatures or may extend up to the vicinity of 100° C. or more. In such cases, because of the quick curing time achieved by the process of this invention, the reactive components can be quickly cured at the elevated temperature to “lock-in” the compatible phase-state in the cured resin before system cool-down. Thus, phase-morphology trapping can be used to produce an optically clear material instead of a translucent or opaque material that would otherwise form upon cooling.

The phase-morphology trapping is yet another advantage presented in the current disclosure. The production of optically clear materials notwithstanding, virtually any thermoplastic may be used as the dead polymer for the production of morphology-trapped materials. Thermoplastic polymers may be chosen in order to give optical clarity, high index of refraction, low birefringence, exceptional impact resistance, thermal stability, UV transparency or blocking, tear or puncture resistance, desired levels or porosity, desired water content upon equilibration in saline, selective permeability to desired permeants (high oxygen permeability, for example), resistance to deformation, low cost, or a combination of these and/or other properties in the finished object.

By way of example, thermoplastic polymers may include, but are not limited to: polystyrene, polystyrene-co-methyl methacrylate, polystyrene-co-acrylonitrile, poly(α-methyl styrene), polymaleic anhydride, polystyrene-co-maleic anhydride, polymethyl(meth)acrylate, polybutyl(meth)acrylate, poly-iso-butyl (meth)acrylate, poly-2-butoxyethyl (meth)acrylate, poly-2-ethoxyethyl (meth)acrylate, poly(2-(2-ethoxy)ethoxy)ethyl (meth)acrylate, poly(2-hydroxyethyl (meth)acrylate), poly(hydroxypropyl (meth)acrylate), poly(cyclohexyl (meth)acrylate), poly(isobornyl (meth)acrylate), poly(2-ethylhexyl (meth)acrylate), polytetrahydrofurfuryl (meth)acrylate, polyethylene, polypropylene, polyisoprene, poly(1-butene), polyisobutylene, polybutadiene, poly(4-methyl-1-pentene), polyethylene-co-(meth)acrylic acid, polyethylene-co-vinyl acetate, polyethylene-co-vinyl alcohol, polyethylene-co-ethyl (meth)acrylate, polyvinyl acetate, polyvinyl butyral, polyvinyl butyrate, polyvinyl valerate, polyvinyl formal, polyethylene adipate, polyethylene azelate, polyoctadecene-co-maleic anhydride, poly(meth)acrylonitrile, polyacrylonitrile-co-butadiene, polyacrylonitrile-co-methyl (meth)acrylate, poly(acrylonitrile-butadiene-styrene), polychloroprene, polyvinyl chloride, polyvinylidene chloride, polycarbonate, polysulfone, polyphosphine oxides, polyetherimide, nylon (6, 6/6, 6/9, 6/10, 6/12, 11, and 12), poly(1,4-butylene adipate), polyhexafluoropropylene oxide, phenoxy resins, acetal resins, polyamide resins, poly(2,3-dihydrofuran), polydiphenoxyphosphazene, mono-, di-, tri-, tetra-, . . . polyethylene glycol, mono-, di-, tri-, tetra-, . . . polypropylene glycol, mono-, di-, tri-, tetra-, . . . polyglycerol, polyvinyl alcohol, poly-2 or 4-vinyl pyridine, poly-N-vinylpyrrolidone, poly-2-ethyl-2-ozazoline, the poly-N-oxides of pyridine, pyrrole, imidazole, pyrazole, pyrazine, pyrimidine, pyridazine, piperadine, azolidine, and morpholine, polycaprolactone, poly(caprolactone)diol, poly(caprolactone)triol, poly(meth)acrylamide, poly(meth)acrylic acid, polygalacturonic acid, poly(t-butylaminoethyl (meth)acrylate), poly(dimethylaminoethyl (meth)acrylate), polyethyleneimine, polyimidazoline, polymethyl vinyl ether, polyethyl vinyl ether, polymethyl vinyl ether-co-maleic anhydride, cellulose, cellulose acetate, cellulose nitrate, methyl cellulose, carboxy methyl cellulose, ethyl cellulose, ethyl hydroxyethyl cellulose, hydroxybutyl cellulose, hydroxypropyl cellulose, hydroxypropyl methyl cellulose, starch, dextran, gelatin, polysaccharides/glucosides such as glucose and sucrose, polysorbate 80, zein, polydimethylsiloxane, polydimethylsilane, polydiethoxysiloxane, polydimethylsiloxane-comethylphenylsiloxane, polydimethylsiloxane-co-diphenylsiloxane, polymethylhydrosiloxane, poly(4-methylpentene-1), and cyclo-olefin copolymers such as ARTON® from JSR, ZEONEX® and ZEONOR® from Nippon Zeon, and TOPAS® from Ticona. The ethoxylated and/or propoxylated versions of the above-mentioned polymers shall also be included under this disclosure as being suitable dead polymers.

In one preferred embodiment, the polymeric precursor mixture comprises a prepolymer, a dead polymer, and optionally a reactive plasticizer and/or a non-reactive plasticizer which gives an optically clear homogeneous molding upon cure. A preferable precursor mixture is a semi-solid.

One group of preferred dead polymers includes the polymers or copolymers comprising sulfoxide, sulfide, and/or sulfone groups within or pendant to the polymer backbone structure. Gels containing these groups have shown reduced protein adsorption in conventional contact lens formulations (see U.S. Pat. No. 6,107,365 and PCT Publ. No. WO00/02937). These polymers and copolymers are readily incorporated into the polymeric precursor mixtures of the present invention.

Additionally preferred dead polymers are those containing one or more pendant or terminal hydroxy groups. Examples of such polymers include polyhydroxyethyl (meth)acrylate, polyhydroxypropyl (meth)acrylate, polyethylene glycol, cellulose, dextran, glucose, sucrose, polyvinyl alcohol, polyethylene-co-vinyl alcohol, mono-, di-, tri-, tetra-, . . . polybisphenol A, and adducts of α-caprolactone with C₂₋₆ alkane diols and triols. Copolymers, ethoxylated, and propoxylated versions of the above-mentioned polymers are also preferred prepolymers.

Copolymers of these polymers with other monomers and materials suitable for use as ophthalmic lens materials are also disclosed. Additional monomers used for copolymerization of the dead polymers may include, by way of example and without limitation, vinyl lactams such as N-vinyl-2-pyrrolidone, (meth)acrylamides such as N,N-dimethyl(meth)acrylamide and diacetone (meth)acrylamide, vinyl acrylic acids such as (meth)acrylic acid, acrylates and methacrylates such as 2-ethylhexyl (meth)acrylate, cyclohexyl (meth)acrylate, methyl (meth)acrylate, isobornyl (meth)acrylate, ethoxyethyl (meth)acrylate, methoxyethyl (meth)acrylate, methoxy triethyleneglycol (meth)acrylate, hydroxytrimeththylene (meth)acrylate, glyceryl (meth)acrylate, dimethylamino ethyl(meth)acrylate and glycidyl (meth)acrylate, styrene, and monomers/backbone units containing quarternary ammonium salts.

The thermoplastics may optionally have small amounts of reactive entities attached (copolymerized, grafted, or otherwise incorporated) to the polymer backbone to promote crosslinking upon cure. They may be amorphous, semi-crystalline, or crystalline. They may be classified as high performance engineering thermoplastics (e.g., polyether imides, polysulfones, polyether ketones, etc.), or they may be biodegradable, naturally occurring polymers (starch, prolamine, and cellulose, for example). They may be oligomeric or macromeric in nature. These examples are not meant to limit the scope of compositions possible during the practice of the current invention, but merely to illustrate the broad selection of thermoplastic chemistries permitted under the present disclosure.

In the present invention, the practice of morphology trapping is not limited to homogeneous systems. Optically transparent phase-separated systems may also be beneficially prepared by including a phase-separated iso-refractive, prepolymer, prepolymer mixture, or a mixture of dead polymers and prepolymers in the system. In that event, compatibility of polymeric components is not required. When a non-reactive diluent is added which partitions itself approximately equally between the phases, a clear part results upon curing. Similarly, when a reactive plasticizer is added which either (1) partitions itself approximately equally between the phases or (2) has a refractive index upon polymerizing similar to that of the dead polymer mixture, a clear part also results upon curing. Alternatively, when the reactive plasticizer does not partition itself equally between the phases and does not possess a refractive index upon curing similar to the polymer mixture, the refractive index of one of the phases may be altered by appropriate choice of the polymer composition to give a resultant iso-refractive mixture. Such manipulations may be advantageously carried out in accordance with the present invention in order to realize heretofore-unattainable properties (i.e., simultaneous mechanical, optical, and processing properties) for a given material system.

With respect to the trapping of phase-separated morphology, one preferred embodiment uses the phase-separated polymeric precursor mixture comprising a prepolymer, a dead polymer, and optionally a reactive plasticizer and/or a non-reactive plasticizer, which upon cure produces a phase-separated iso-refractive molding. More preferably, the precursor mixture is a semi-solid. Most preferably, the precursor mixture is a semi-solid which has a high refractive index.

The phase-morphology trapping of the present invention is not restricted to the optically clear systems. In fact, the invention is applicable to virtually any morphologies which can be created in the polymeric precursor mixtures of this invention. Most polymer blends and block copolymers, and many other copolymers, result in phase-separated systems, providing an abundance of phase configurations to be exploited by the materials designer. Polymer blends achieved by physically mixing two or more polymers are often used to elicit desirable mechanical properties in a given material system. For example, impact modifiers (usually lightly crosslinked particles or linear polymer chains) may be blended into various thermoplastics or thermoplastic elastomers to improve the impart strength of the final cured resin. In practice, such blends may be mechanical, latex, or solvent-cast blends; graft-type blends (surface modification grafts, occasional grafts (IPNs, mechanochemical blends)), or block copolymers. Depending on the chemical structure, molecule size, and molecular architecture of the polymers, the blend may result in mixtures comprising both compatible and incompatible, amorphous, semi-crystalline or crystalline constituents.

The physical arrangement of the phase domains may be simple or complex, and may exhibit continuous, discrete/discontinuous, and/or bicontinuous morphologies. Some of these are illustrated by the following examples: spheres of phase I dispersed in phase II; cylinders of phase I dispersed in phase II; interconnected cylinders; ordered bicontinuous, double-diamond interconnected cylinders of phase I in phase II (as have been documented for star-shaped block copolymers); alternating lamellae (well-known for di-block copolymers of nearly equal chain length); rings forming nested spherical shells or spirals; phase within a phase within a phase (HIPS and ABS); and simultaneous multiples of these morphologies resulting from the thermodynamics of phase separation (both nucleation and growth as well as spinodal decomposition mechanisms), kinetics of phase separation, and methods of mixing, or combinations thereof.

Another category of materials utilizes “thermoplastic elastomers” as the dead polymer or prepolymer. An exemplary thermoplastic elastomer is a tri-block copolymer of the general structure “A-B-A”, where A is a thermoplastic rigid polymer (i.e., having a glass transition temperature above ambient) and B is an elastomeric (rubbery) polymer (glass transition temperature below ambient). In the pure state, ABA forms a microphase-separated or nanophase-separated morphology. This morphology consists of rigid glassy polymer regions (A) connected and surrounded by rubbery chains (B), or occlusions of the rubbery phase (B) surrounded by a glassy (A) continuous phase. Depending on the relative amounts of (A) and (B) in the polymer, the shape or configuration of the polymer chain (i.e., linear, branched, star-shaped, asymmetrical star-shaped, etc.), and the processing conditions used, alternating lamellae, semi-continuous rods, or other phase-domain structures may be observed in thermoplastic elastomer materials. Under certain compositional and processing conditions, the morphology is such that the relevant domain size is smaller than the wavelength of visible light. Hence, parts made of such ABA copolymers can be transparent or at worst translucent. Thermoplastic elastomers, without vulcanization, have rubber-like properties similar to those of conventional rubber vulcanizates, but flow as thermoplastics at temperatures above the glass transition point of the glassy polymer region. Commercially important thermoplastic elastomers are exemplified by SBS, SIS, and SEBS, where S is polystyrene and B is polybutadiene, I is polyisoprene, and EB is ethylenebutylene copolymer. Many other di-block or tri-block candidates are known, such as poly(aromatic amide)siloxane, polyimide-siloxane, and polyurethanes. SBS and hydrogenated SBS (i.e., SEBS) are well-known products from Kraton Polymers Business (KRATON®). DuPont's LYCRA® is also a block copolymer.

When thermoplastic elastomers are chosen as the dead polymer for formulation, exceptionally impact-resistant yet clear parts may be manufactured. The thermoplastic elastomers, by themselves, are not chemically crosslinked and require relatively high-temperature processing steps for molding. Upon cooling, such temperature fluctuations lead to dimensionally unstable, shrunken or warped parts. The prepolymers, if cured by themselves, may be chosen to form a relatively glassy, rigid network or a relatively soft, rubbery network, but with relatively low shrinkage in either case. When thermoplastic elastomers (i.e., dead polymers) and prepolymers are mixed together and reacted to form a cured resin, however, they form composite networks with superior shock-absorbing and impact-resistant properties, while exhibiting relatively little shrinkage during cure. By “impact-resistant” is meant resistance to fracture or shattering upon being struck by an incident object. Reactive plasticizers may also be included to promote crosslinking reaction and to achieve semi-solid consistency. For the systems containing thermoplastic elastomers, the impact strength may be increased further by compression molding the precursor mixtures prior to curing.

Depending on the nature of the prepolymers, dead polymers, diluents and/or reactive plasticizers used in the formulation, the final cured resin may be more flexible or less flexible (alternatively, harder or softer) than the dead polymer. Composite articles exhibiting exceptional toughness may be fabricated by using a thermoplastic elastomer which itself contains polymerizable groups along the polymer chain. A preferred composition in this regard would be SBS tri-block or star-shaped copolymers, for example, in which the reactive plasticizer is believed to crosslink lightly with the unsaturated groups in the butadiene segments of the SBS polymer. The final cured moldings which contain these polymers also show good scratch resistance and solvent resistance because the cured moldings comprise the crosslinked network of prepolymers and dead polymers.

In one preferred embodiment of the present invention, the polymeric precursor mixture comprises a prepolymer, a thermoplastic elastomer, and optionally a reactive plasticizer and/or a non-reactive diluent. A preferred thermoplastic elastomer is the SBS copolymer.

A preferred formulation for developing optically clear and highly impact-resistant materials uses styrene-rich SBS tri-block copolymers that contain up to about 75% styrene. These SBS copolymers are commercially available from Kraton Polymers Business (KRATON®), Phillips Chemical Company (K-RESIN®), BASF (STYROLUX®), Fina Chemicals (FINACLEAR®), Asahi Chemical (ASAFLEX®), and others. In addition to high impact resistance and good optical clarity, such styrene-rich copolymers yield material systems which exhibit other sometimes desirable properties such as a relatively high refractive index (that is, an index of refraction equal to or greater than about 1.54) and/or low density (with 30% or less of a reactive plasticizer, their densities are less than about 1.2 g/cc, and more typically about 1.0 g/cc).

In another embodiment of this invention, the precursor mixture is a phase-separated system comprising a prepolymer, a thermoplastic elastomer, and optionally a reactive plasticizer and/or a non-reactive plasticizer which upon cure produces an optically clear phase-separated iso-refractive molding. More preferably, the precursor mixture is a semi-solid. Most preferably, the precursor mixture is a semi-solid which has a high refractive index.

When the mixture refractive index is an especially important consideration, high refractive index polymers may be used as one or more of the dead-polymer components. Examples of such polymers include polycarbonates and halogenated and/or sulfonated polycarbonates, polystyrenes and halogenated and/or sulfonated polystyrenes, polystyrene-polybutadiene block copolymers and their hydrogenated, sulfonated, and/or halogenated versions (all of which may be linear, branched, star-shaped, or non-symmetrically branched or star-shaped, etc.), polystyrene-polyisoprene block copolymers and their hydrogenated, sulfonated and/or halogenated versions (including the linear, branched, star-shaped, and nonsymmetrical branched and star-shaped variations, etc.), polyethylene or polybutylene terephthalates (or other variations thereof), poly(pentabromophenyl (meth)acrylate), polyvinyl carbazole, polyvinyl naphthalene, poly vinyl biphenyl, polynaphthyl (meth)acrylate, polyvinyl thiophene, polysulfones, polyphenylene sulfides or oxides, polyphosphine oxides or phosphine oxide-containing polyethers, urea-, phenol-, or naphthyl-formaldehyde resins, polyvinyl phenol, chlorinated or brominated polystyrenes, poly(phenyl α- or β-bromoacrylate), polyvinylidene chloride or bromide, and the like.

As stated previously, increasing the aromatic content, the halogen content (especially bromine), and/or the sulfur content are generally effective means well known in the art for increasing the refractive index of a polymeric material. High index, low density, and resistance to impact are properties especially preferred for ophthalmic lenses as they enable the production of ultra thin, lightweight eyeglass lenses, which are desirable for low-profile appearances and comfort and safety of the wearer.

Alternatively, elastomers, thermosets (e.g., epoxies, melamines, acrylated epoxies, acrylated urethanes, etc., in their uncured state), and other non-thermoplastic polymeric compositions may be desirably utilized as the dead polymers during the practice of this invention.

One embodiment of the process of the present invention consists of three steps: 1) polymerization, 2) functionalization or derivatization, and 3) molding and curing. Polymeric precursor mixtures are produced by the continuous process which comprises polymerization and functionalization or derivatization steps. The continuous process of this invention is economical because it eliminates the costly steps of isolation and recovery of prepolymers. The present process also eliminates the mixing of prepolymers with dead polymers, non-reactive plasticizers, and/or reactive plasticizers, which often has to be carried out at high temperatures where the degradation of polymers becomes a problem.

In the polymerization step, the polymerization catalyst can be a thermal initiator which generates free radicals at moderately elevated temperatures. Thermal initiators such as lauryl peroxide, benzoyl peroxide, dicumyl peroxide, t-butyl hydroperoxide, azobisisobutyronitrile (AIBN), potassium or ammonium persulfate, for example, are well known and are available from chemical suppliers such as Aldrich. Photoinitiators may be used in place of or in combination with one or more thermal initiators so that the polymerization reaction may be triggered by a source of actinic or ionic radiation. Photoinitiators such as the Irgacure® and Darocur® series are well-known and commercially available from Ciba Geigy, as is the Esacure® series from Sartomer. Examples of photoinitiator systems are bis(2,6-dimethoxybenzoyl)-2,4,4-trimethylpentyl phosphine oxide, benzoin methyl ether, 1-hydroxycyclohexyl phenyl ketone, 2-hydroxy-2-methyl-1-phenylpropane-1-one (sold under the Tradename DAROCUR 1173 by Ciba Specialty Chemicals), and 4,4′-azobis(4-cyano valeric acid), available from Aldrich Chemicals. For a reference on initiators, see, for example, Polymer Handbook, J. Brandrup, E. H. Immergut, eds., 3rd Ed., Wiley, New York, 1989.

Polymerization may be carried out using solvents and/or in the presence of non-reactive diluents which constitute the final precursor mixtures. Solvents are removed after the functionalization or derivatization step. Preferred solvents are volatile solvents which can be readily removed by evaporation or vacuum distillation. If the precursor mixtures for isometric casting are desired, the amount of non-reactive diluents is adjusted such that the moldings exhibit little net change in the volume after equilibration in physiological salt solutions.

Solvents may be advantageously used to decrease the viscosity of the reaction medium, which provides a good mixing of solution. The reduction of solution viscosity also avoids the mixing at elevated temperatures and/or with high shearing, which often degrades polymers. In addition, for the monomer mixtures that contain multifunctional monomers, the presence of solvents eliminates or minimizes the formation of insoluble gels during the polymerization reaction by decreasing the monomer concentration. Volatile solvents also assist the removal of residual impurities by evaporation or vacuum distillation after the functionalization step.

Purification of the polymer at any stage of the process, i.e., either before or after functionalization, can be achieved by conventional methods, examples of which are evaporation, vacuum distillation, and vacuum drying. Purification can also be achieved by filtration, including microfiltration to remove particulates and ultrafiltration to remove material below a particular molecular weight that is determined by the selection of the utlrafiltration membrane.

An example of an ultrafiltration process is that disclosed in U.S. Pat. No. 6,072,020 (Arcella et al., Jun. 6, 2000), incorporated herein by reference. According to such a process, the polymer after functionalization and still dissolved in the solvent in which functionalization has been performed is filtered by semi-permeable membranes with pores in the range of 0.05 micron to 0.5 micron, followed by a second stage filtration using membranes with pores with a molecular weight limit of 5-500 kDa. The second stage filtration is performed under a gradient of a second volatile solvent such as ethanol or methanol. Displacement of all of the first solvent by the second solvent may involve six volumes of the second solvent relative to the initial volume of the first solvent. The non-aqueous diluent can then be added and the solvent removed by reduced pressure evaporation to give the composition ready for casting and curing.

In the present invention, the dead polymers may also be added to the reaction medium at a desired time before, during, and/or after the polymerization reaction, and/or after the functionalization reaction. As stated previously, the dead polymers may be advantageously utilized to produce desired morphologies, which depend on the components and compositions of the reaction formulations as well as on the processing conditions such as temperatures, pressures, and mixing conditions. The compositions of reaction media change as the reaction proceeds. Thus, in the process of this invention, the desired morphologies of polymeric precursor mixtures may be obtained by manipulating the time of addition of dead polymers to the reaction media, which is yet another advantage presented in the current disclosure.

After the polymerization reaction, polymers are functionalized with reactive groups to give prepolymers. The reaction chemistry of functionalization depends on the type of functionalizable groups on the polymer backbone and the reaction condition is chosen accordingly. For example, the functionalization reaction of hydroxyls by methacrylic anhydride proceeds spontaneously at room temperature without using a catalyst.

The process of the present invention is particularly useful for producing the semi-solid precursor mixtures which contain thermally sensitive polymers such as the high-refractive index polymers for ophthalmic lenses comprising sulfurs and/or halogens. When semi-solid precursor mixtures are obtained by blending prepolymers and reactive plasticizers, mixing often has to be carried out at high temperatures (e.g., above 250° C.) where the degradation of polymers becomes a problem. In the present invention, the semi-solid precursor mixtures are obtained at moderate temperatures, preferably at temperatures below 150° C. and more preferably below 100° C.

Upon completing the functionalization or derivatization reaction, an initiator or polymerization catalyst is also typically added into the polymeric precursor mixture in order to facilitate curing upon exposure of the precursor mixture to a source of polymerizing energy such as light or heat. Optionally, other additives may be included in the precursor mixtures such as mold release agents, preservative agents, pigments, dyes including photochromic dyes, organic or inorganic fibrous or particulate reinforcing or extending fillers, thixotropic agents, indicators, inhibitors or stabilizers (weathering or non-yellowing agents), UV absorbers, surfactants, flow aids, chain transfer agents, foaming agents, porosity modifiers, and the like. The initiator and other optional additives may be dissolved or dispersed in the reactive plasticizer and/or diluent component prior to combining with the dead polymer and/or prepolymer to facilitate complete dissolution into and uniform mixing with the polymeric component(s).

For the production of ophthalmic moldings, the crucial criteria in determining whether a polymeric precursor mixture can be employed in the novel process of the present invention are that the precursor mixture must be homogeneous to a sufficient degree allowing for optical clarity upon cure; that the mixture be capable of undergoing a polymerization reaction upon the application of light, heat, or some other form of polymerizing energy or polymerization-triggering mechanism; and, for semi-solid precursors, that the mixture exhibit a semi-solid consistency during at least one part of the manufacturing process used to produce the molding of interest.

The semi-solid precursor materials of the present invention may be advantageously molded by several different molding techniques well-known and commonly practiced in the art. For example, static casting techniques, where the molding material is placed between two mold halves which are then closed to define an internal cavity which in turn defines the molding shape to be produced, are well-known in the field of ophthalmic lens production. See, for example, U.S. Pat. Nos. 4,113,224, 4,197,266, and 4,347,198. Likewise, compression molding techniques where two mold halves are again brought together, but not necessarily brought into contact with one another, to define one or more molded surfaces, are well-known in the field of thermoplastic molding. Injection molding is another technique that may be adapted for use with the present semi-solid precursor materials of the present invention, where the semi-solid material can be rapidly forced into a cavity defined by two temperature-controlled mold halves, the material being optionally cured while in the mold, then being ejected from the mold halves with a subsequent shaping and or curing step if needed (if the semi-solid is not cured or only partially cured in the injection molding machine).

Such processes without curing or with only partial curing in the mold are suitable for the production of preforms as long as the preforms maintain semi-solid consistency. The preforms may take the form of slabs, disks, balls, or sheets, for example, which can be later used in a static casting or compression molding process with curing to manufacture the final objects of interest. For the production of ophthalmic lenses, static casting, compression, and injection molding are all preferred processes because of their current prevalence in the art with either unreactive thermoplastic materials (injection and compression molding) or reactive precursors in a liquid state (static casting).

The following examples are offered as illustration and are not intended to limit the scope of the invention.

### EXAMPLE 1

A temperature-controlled 250-mL four-neck flask equipped with a thermometer, condenser, and nitrogen inlet was charged with 10 g of polyethylene glycol having an average molecular weight of 400 (PEG 400, Aldrich) as a non-reactive non-volatile diluent and 20 g of acetone as a volatile solvent. The mixture was stirred for a few minutes before adding 10 g of 2-hydroxyethyl methacrylate (HEMA), 0.15 g of methacrylic acid (MAA), and 12 mg of azobisisobutyronitrile (AIBN) as an initiator. The mixture was then purged with purified nitrogen while stirring for approximately 15 minutes.

The solution was slowly heated to and maintained at 60° C. for 2 hours to carry out polymerization. After polymerization, a clear and highly viscous liquid, semi-solid, or hydrogel was formed. The mixture was then cooled down to room temperature and 0.21 g of methacrylic anhydride (MA) was injected as a functionalizing agent. The reaction between the hydroxyl of HEMA and MA proceeds spontaneously at room temperature without using a catalyst. The solution was stirred for 12 hours to carry out the functionalization reaction in which the reactive methacrylic groups were introduced on the polymer backbone. Upon the completion of functionalization reaction, volatile acetone and residual impurities were removed by evaporation or vacuum distillation to give a polymeric precursor mixture comprising PEG 400 and methacrylate-functionalized pHEMA-co-MAA copolymer. The resulting material was a highly viscous liquid, semi-solid, or hydrogel.

In this example, the concentration of acetone in the reaction mixture can be varied from 10 wt % to 80 wt %. When the acetone concentration was higher than 80 wt %, the pHEMA-co-MAA copolymer precipitated during polymerization. When the acetone concentration was below 10 wt %, significant gellation occurred. The gellation is caused by the crosslinking of copolymer due to the small amount of difunctional monomer present in HEMA as impurities. The properties of the precursor mixtures can be varied by variations in the choice of solvent, solvent concentration, reaction time, reaction temperature, and concentration of diluents.

The degree of functionalization can be readily varied by adjusting the amount of MA added to the reaction mixture as a functionalizing agent. While keeping the amounts of HEMA and MAA unchanged, various pHEMA-co-MAA copolymers with functionalities from 0.3 to 5% have also been synthesized according to the procedure described above by adjusting the amount of MA. Using suitable substituting agents, other types of reactive groups (e.g., acrylate and methacrylamide) may also be introduced to the backbone of pHEMA-co-MAA.

### EXAMPLE 2

A reaction vessel identical to that of Example 1 was charged with 15 g of PEG 400 and 18 g of acetone. The mixture was stirred for a few minutes before adding 15 g of HEMA, 0.21 g of MAA, and 15 mg of AIBN. The mixture was then purged with nitrogen while stirring for approximately 15 minutes. Next, the solution was slowly heated to and maintained at 60° C. for 3 hours to carry out polymerization. Because the viscosity of reaction medium increases during polymerization, it may be advantageous to add more solvent to the reaction medium during polymerization to ensure the completion of the reaction and to reduce the crosslinking of copolymer. In this example, 10 g of acetone was further added to the reaction mixture after one hour from the start of polymerization reaction and additional 10 g of acetone was also added to the solution after 2 hours from the start of polymerization.

After polymerization, the reaction mixture was cooled down to room temperature and 0.32 mL of MA was added. The solution was kept under vigorous stirring for 12 hours to carry out the functionalization reaction. Finally, volatile acetone and residual impurities were removed by vacuum distillation.

### EXAMPLE 3

A copolymer pHEMA-co-MAA was synthesized according to the procedure described in Example 1. After polymerization, 0.18 g of glycidyl methacrylate was injected as a functionalizing agent into the reaction mixture and the functionalization reaction was carried out at room temperature for 24 hours under vigorous stirring. The volatile solvent and residual impurities were then removed by vacuum distillation. The resulting precursor mixture was a clear semi-solid that is suitable for biomedical products and devices which require minimum purification step prior to their intended use.

### EXAMPLE 4

The reaction vessel was charged with 10 g of PEG 400 and 20 g of acetone. The mixture was stirred for a few minutes before adding 10 g of HEMA, 0.15 g of MAA, and 10 mg of AIBN. Subsequently, the reaction mixture was purged with purified nitrogen while stirring for approximately 15 minutes. The solution was then slowly heated to and maintained at 60° C. for 2 hours to carry out polymerization. After polymerization, a clear mixture was obtained which was a highly viscous liquid, semi-solid, or hydrogel. The mixture was cooled down to room temperature and 0.21 g of MA was injected. The solution was stirred for 12 hours to carry out the functionalization reaction by introducing reactive methacrylic groups to the copolymer backbone. Upon completing the functionalization reaction, a photoinitiator such as IRGACURE 184, DAROCUR 1173, or IRGACURE 1750 was mixed with the solution at 1 wt % with respect to the total monomer content. Finally, volatile acetone and residual impurities were removed by vacuum distillation.

Depending on the reaction conditions, the resulting precursor mixture was a highly viscous liquid, semisolid, or hydrogel containing a photoinitiator. The precursor mixture obtained in this example is ready for molding and curing without mixing further with an initiator.

### EXAMPLE 5

A procedure similar to that used in Examples 1 to 4 was used to synthesize pHEMA or pHEMA-co-MAA using different solvents. The component and composition of other constituents of the reaction mixture remained unchanged. Instead of acetone, methyl ethyl ketone (MEK), tetrahydrofuran (THF), or a combination of both was added to the reaction mixture as a volatile solvent. The advantage of using MEK or THF over acetone is that because these solvents have relatively higher boiling points, polymerization can be carried out at temperatures around 70° C. which cannot be achieved with the more volatile acetone. MEK and THF are still volatile enough however to be readily removed by evaporation or vacuum distillation. Polymerization reactions, particularly free radical polymerizations, proceed faster and closer to completion at higher temperatures. For the pHEMA and pHEMA-co-MAA synthesized in this example, the disadvantage is that these polymers have lower solubility in MEK and THF than in acetone. To prevent the precipitation of the copolymers, the concentration of MEK or THF should be kept below 50-60%, preferably below 50%, with respect to the total amount of reaction mixture.

### EXAMPLE 6

A reaction vessel identical to that of Example 1 was charged with 10 g of PEG 400 and 40 g of ethanol. The mixture was stirred for a few minutes before adding 10 g of HEMA, 0.15 g of MAA, and 10 mg of AIBN. Subsequently, the mixture was purged with nitrogen while stirring for approximately 15 minutes. The solution was then slowly heated to and maintained at 60° C. to carry out polymerization for 2.5 hours. Because ethanol is a better solvent for the copolymer synthesized here than acetone, using ethanol as a solvent, the amount of solvent in the reaction mixture can be increased to decrease the monomer concentration below the lowest monomer concentration achievable with the use of acetone as a solvent. After polymerization, a clear and viscous liquid was obtained.

The hydroxy group of ethanol, however, may preferably reacts with MA used as a functionalizing agent in the following functionalization step. To minimize the side reaction between ethanol and MA, ethanol was removed under vacuum and one or more of non-aqueous solvents, such as acetone, THF, and MEK were added to the mixture containing pHEMA-co-MAA copolymer and PEG 400.

The copolymer was functionalized by adding 0.32 g of MA to the solution. The mixture was stirred vigorously for 12 hours at room temperature. After the functionalization reaction is completed, volatile solvents and residual impurities were removed by vacuum distillation.

The resulting precursor mixture is a highly viscous liquid, semi-solid, or hydrogel. Compared to the copolymers synthesized in Examples 1 to 4, the copolymer synthesized in this example is less crosslinked because a lower monomer concentration was used during the polymerization reaction.

### EXAMPLE 7

A reaction vessel identical to that of Example 1 was charged with 10 g of PEG 400 and 20 g of acetone. The mixture was stirred for a few minutes before adding 8 g of HEMA, 1.5 g of N-vinyl-2-pyrrolidone, 0.5 g of MAA, and 10 mg of AIBN. Subsequently, the mixture was purged with nitrogen while stirring for approximately 15 minutes. The solution was then slowly heated to and maintained at 60° C. to carry out polymerization for approximately 3 hours. After polymerization, the mixtures was clear and a semi-solid or hydrogel was obtained. The mixture was cooled down to room temperature and 0.55 g of MA was injected. The solution was then stirred for 12 hours to carry out the functionalization reaction by introducing reactive methacrylic groups on the copolymer backbone. Upon completing the functionalization reaction, volatile acetone and residual impurities were removed by vacuum distillation.

The resulting precursor mixture was a highly viscous liquid, semi-solid, or hydrogel. The prepolymer synthesized in this example has a relatively high degree of functionalization and therefore will crosslink upon cure more than the prepolymers synthesized in the previous examples.

### EXAMPLE 8

This example describes the molding and curing process to produce contact lenses. The precursor mixture comprises 50 wt % of 0.75% functionalized pHEMA-co-MAA and 50 wt % of PEG 400. 0.1 Gram of this precursor mixture was first mixed with 0.002 g of IRGACURE 184 (a photoinitiator) by hand between two glass plates for a few minutes. For the precursor mixtures which already contain photoinitiators, it is not necessary to mix the precursor mixture with a photoinitiator prior to molding.

Approximately 0.08 g of the resulting material was then placed between two contact lens molds made of polystyrene. The assembly was placed on a press at 50° C. with slight pressure to controllably bring the molds into contact with each other around their periphery. Excess material was squeezed out of the mold as the two molds came together, and the amount of overflow was determined by the amount of material originally placed into the mold versus the mold cavity volume. For the molds made of polystyrene, higher molding temperatures up to about 80° C. may be utilized without deforming the molds.

The molding procedure described above was found to squeeze out the air bubbles which are occasionally trapped in the precursor mixtures when the mixtures are manually transferred to the molds. It is desirable however to completely eliminate air bubbles from the precursor mixtures before closing the molds. One approach to remove air bubbles from the precursor mixtures in the molds is to place the material in a rear contact lens mold and apply a slight vacuum on the mold for approximately 10 minutes. Alternatively, the material may be left in a rear mold for several hours to one day, during which the precursor mixture slowly settles down and the air bubbles often come out from the precursor mixture spontaneously without applying a vacuum, or many small air bubbles coalesce into a few large bubbles which are readily squeezed out by simply closing the molds. These two approaches are quite effective in removing the trapped air bubbles from the precursor mixtures in the molds. The latter approach, however, may not be effective for highly viscous semi-solid precursor mixtures.

Once the molds were pressed together, the ophthalmic molding was cured for approximately 20 seconds under a Fusion UV light source using the D-, H-, or V-bulb. For a given photoinitiator, the type of light bulb is chosen accordingly to achieve the optimum absorption of light by the photoinitiator. It should be noted that shorter curing times are possible, and 20 seconds serves as an upper limit for the amount of time required to cure this particular molding composition and geometry. The mold assembly was then removed from the UV lamp, and the overflow material was trimmed from the edge of the lens molds. The lens molds were opened after allowing them to cool to room temperature, and an ophthalmic contact lens was thus obtained.

The ophthalmic lens of the present example contains an equilibrium water content of approximately 50-60%, which depends on the copolymer composition, degree of functionality of the copolymer which determines the crosslinking density of cured lens. Polymers functionalized at about 0.5 to 1% exhibited mechanical moduli similar to those seen for commercial contact lens materials having similar water contents, and were able to stretch to 2-4 times their original length before breaking.

The molding and curing procedure described in this example is a general procedure which may be applicable to any precursor mixtures for contact lenses obtained by the present invention.

### EXAMPLE 9

In a slightly different molding and curing process from the process described in Example 8, a visible light initiator 4,4′-azobis(4-cyanovaleric acid) was mixed with the precursor mixtures of Examples 1 to 3 at 1 wt %. The ophthalmic molds containing the precursor mixtures were prepared according to the procedure described in Example 8 and were cured by a high intensity illumination source (Fiber-Lite Ringlight System, Dolan-Jenner) for 20 minutes. Curing times can be shortened by using more intense visible light sources.

### EXAMPLE 10

0.08 Gram of the precursor mixture from Example 4 was placed in a pair of contact lens molds. The mixing with initiator was not necessary for this precursor mixture because a photoinitiator had been already dissolved in the mixture during the preparation of precursor mixture. The lens molds were closed by the procedure described in Example 8 and the mold assembly was cured by a diffuse UV light source (Blak-Ray 100 AP, UVP, Inc.) for 10 minutes. Curing times can be shortened by using more intense UV light sources.

The cured lens was removed from the molds and was hydrated in a buffered saline solution. The equilibrium water content was 54%, and the sample lens had an elongation to break of approximately 250%.

### EXAMPLE 11

The number and amount of diluents may be chosen according to the requirements and desired properties. In particular, the number and amount of diluents may be adjusted to achieve isometric exchange between the diluents and physiological saline solution. The easiest approach is to add the desired amount of diluents in the polymerization step. In rare occasions, the diluents may be adjusted before the molding process.

As an example, 0.1 g. of isopropanol and 0.15 g. of alkoxylated glucosides were mixed 0.167 g. of material synthesized according to Example 5. The mixture was then placed in a rear contact lens mold and degassed for 5 minutes. Subsequently, the mold assembly was pressed slightly and UV cured for 20 seconds.

In general a contact lens thus obtained has essentially the exact shape and diameter as the contact lens mold since the molding material contains the amount of diluent which is the same as the equilibrium water amount once the lens is immersed in the physiological saline solution. Consequently, a isometric exchange of diluents and water is achieved.

### EXAMPLE 12

A clear solution consisting of 1 mL of PEG 400, 33 mL of acetone, 1 mL of HEMA and 0.21 mL of MA was prepared. To the mixture were added 1.5 mg. of Blue HEMA, 50 mg. of UV block N7966 and 12 mg. of AIBN. The mixture was stirred under nitrogen purge for approximately 15 minutes. Subsequently, the temperature was raised to 58° C. and the monomers were polymerized for 90 minutes. After the polymerization, a clear, bluish concentrated polymer solution or semi-solid was formed. To introduce the reactive sites, 0.35 mL of methacrylic anhydride was injected after the concentrated solution or gel was cooled down to room temperature. The mixture was stirred for 12 hours for derivatization. Finally, the volatile solvent and residual impurities were removed by vacuum distillation.

The resulting material was used in making contact lenses, intraocular lenses and biomedical devices.

### EXAMPLE 13

For ophthalmic lenses which have high refractive indices, the semi-solid precursor mixtures are obtained from the prepolymers comprising high-refractive index monomers. As an example, the starting monomer mixture comprises chlorostyrene, a high-refractive index monomer, and 3-phenoxy-2-hydroxypropyl methacrylate which contains a functionalizable hydroxyl. Another example of monomer mixture comprises bromostyrene, a high-refractive index monomer, and 3-(2,4-dibromo-3-methylphenoxy)-2-hydroxypropyl (meth)acrylate which also gives high-refractive index and has a functionalizable hydroxyl.

Upon completing the polymerization reaction in a suitable solvent, methacrylic anhydride is added to the polymer solution to carry out functionalization to obtain the prepolymers functionalized with reactive methacrylate groups. Next, reactive plasticizers and photoinitiators are added to the prepolymer solution. The types and relative amounts of reactive plasticizers are selected accordingly to obtain desired properties of precursor mixtures and cured articles such as semi-solid consistency, high-impact strength, and high-refractive index, while maintaining optical clarity. Solvents are then removed to give semi-solid precursor mixtures for high-refractive index ophthalmic lenses which can be cured rapidly by UV.

### EXAMPLE 14

Semi-solid precursor mixtures suitable for ophthalmic lenses are also produced from phase-separated iso-refractive systems using styrene-rich SBS block copolymers as dead polymers which show good impact strength. Commercially available styrene-rich SBS block copolymers such as KRATON® from Kraton Polymers Business and K-RESIN® from Phillips Chemical Company have refractive indices of about 1.57. Examples of prepolymers which are incompatible with SBS block copolymers are functionalized versions of styrene-methyl methacrylate (SMMA) copolymers, styrene-acrylonitrile (SAN) copolymers, and styrene-maleic anhydride (SMA) copolymers in which the copolymer compositions are adjusted such that the refractive indices of prepolymers match the refractive index of SBS block copolymer at room temperature. SMMA and SAN copolymers are also copolymerized with the monomers which contain functionalizable groups. The anhydride group of SMA can be functionalized with suitable functionalizing agents such as those containing hydroxyls.

As an example, a copolymer is synthesized from a monomer mixture comprising styrene, methyl methacrylate, and 2-hydroxyethyl methacrylate (HEMA) in a suitable solvent. The polymerization may be carried out in the presence of SBS block copolymers as dead polymers. If desired, dead polymers are mixed with the prepolymer solution after completing functionalization. The resulting morphologies may depend on the time of addition of dead polymers to the reaction mixture.

Hydroxyls of HEMA are functionalized with reactive methacrylate groups using methacrylic anhydride as a functionalizing agent. Upon completing functionalization, reactive plasticizers and photoinitiators are added to the reaction mixture. The types and relative amounts of reactive plasticizers are chosen accordingly to achieve desired semi-solid consistency without losing optical clarity. For the mixtures of SBS block copolymer and SMMA copolymer, examples of reactive plasticizers include ethoxylated bisphenol A di(meth)acrylates and benzyl (meth)acrylate.

Solvent is then removed from the mixture to give a phase-separated iso-refractive semi-solid precursor mixture. For the systems containing SBS block copolymers, the impact strength of cured articles can be increased further by performing compression molding on the semi-solid precursor mixtures prior to cure. Thus, compression-molded preforms may be advantageously obtained for the semi-solid precursor mixtures which contain SBS block copolymers. These preforms are used later for the manufacture of final objects of interest such as ophthalmic lenses which have relatively high refractive indices and good impact strength.

### EXAMPLE 15

This example illustrates the preparation of a copolymer of 2-hydroxyethyl methacrylate, methacrylic acid, and blue HEMA, using ethanol as a solvent for the polymerization reaction.

A 1000-mL four-neck flask, equipped with a thermometer, condenser, nitrogen inlet, and thermocouple, was charged with 53.65 g of 2-hydroxyethyl methacrylate (HEMA), 1.07 g of methacrylic acid (MAA), 6 mg of blue HEMA, and 500 mL of ethanol. The mixture was purged with high purity nitrogen gas and stirred for approximately 15 min. Subsequently, 0.82 g of azobisisobutyronitrile (AIBN) was added and the solution was stirred until the AIBN dissolved. Polymerization was conducted by heating the solution to 70° C. and maintaining that temperature for 5 hours.

After the completion of polymerization, the solution was allowed to cool to room temperature. The solution was then transferred to a funnel and slowly dropped into 3000 mL of stirred hexane. A bluish solid copolymer precipitated and was collected by filtration, then placed in a vacuum oven for 24 hours, leaving a dry solid. The yield of dried solid was 90%.

### EXAMPLE 16

This example illustrates the functionalization of the copolymer prepared in Example 15 with methacrylic anhydride, using pyridine as a solvent for the functionalization reaction.

Under an inert atmosphere, a 250-mL round-bottom flask equipped with stir bar and septum was charged with 5.29 g of poly(HEMA-co-MAA) synthesized according to Example 15. Anhydrous pyridine (50 mL) was added and the mixture was stirred until the polymer had completely dissolved. Methacrylic anhydride (94 mg) was then added and the resulting mixture was allowed to stir at ambient temperature overnight. The resulting solution of poly(HEMA-co-MAA) functionalized with methacrylic anhydride was then slowly poured into a beaker containing 450 mL of vigorously stirred hexanes causing precipitation of the functionalized copolymer as a sticky viscous oil. The product so obtained was allowed to redissolve with stirring in 100 mL ethanol and then re-precipitated as a well dispersed solid by slow addition to 550 mL of vigorously stirred hexanes. Decantation and washing of the solids with two additional portions of hexanes, followed by drying in vacuo gave 4.57 g of free-flowing light blue powder.

### EXAMPLE 17

This example illustrates the further processing of the functionalized copolymer prepared in Example 16 to prepare the copolymer for crosslinking in a mold, using methanol to facilitate the dissolving of the copolymer and the transfer of the copolymer to the mold.

The functionalized copolymer prepared in Example 16 (0.6 gram) was combined with PEG 400 (0.9 g), and IRGACURE 184 (0.006 g) in a methanol (2 g) solution. Approximately 0.2 g of the solution was placed in a front mold half which was then placed in a vacuum oven to remove the methanol. The result was a viscous or semi-solid composition ready for final molding and curing.

The foregoing is offered primarily for purposes of illustration. Further variations and substitutions that are still within the scope of this invention will be readily apparent to those skilled in the art.

1. A process for the manufacture of a molded hydrogel, said process comprising:
(a) casting a composition comprising
(i) a crosslinkable non-water-soluble polymer which when crosslinked by a crosslinking reaction and saturated with water forms a hydrogel containing a predetermined volumetric proportion of water, and
(ii) a non-aqueous diluent that is inert to said crosslinking reaction, said non-aqueous diluent being in a volumetric proportion substantially equal to said predetermined volumetric proportion of water in said hydrogel,
in a mold under conditions causing conversion of said composition to a non-aqueous gel by crosslinking said crosslinkable non-water-soluble polymer; and
(b) substituting an aqueous liquid for said non-aqueous diluent in said nonaqueous gel to form said hydrogel.

2. A process in accordance with claim 1 in which said composition is a semi-solid.

3. A process in accordance with claim 1 in which said composition is a viscous liquid.

4. A process in accordance with claim 1 in which said aqueous liquid is an aqueous physiological saline solution.

5. A process in accordance with claim 1 further comprising (A) forming said crosslinkable non-water-soluble polymer by coupling a functionalizing agent to a non-water-soluble precursor polymer, said functionalizing agent defined as an agent that when so coupled is capable of undergoing a crosslinking reaction.

6. A process in accordance with claim 5 in which step (A) comprises coupling said functionalizing agent to said non-water-soluble precursor polymer in said non-aqueous diluent to form said composition.

7. A process in accordance with claim 5 in which step (A) comprises (A.1) coupling said functionalizing agent to said non-water-soluble precursor polymer to form said crosslinkable non-water-soluble polymer, and (A.2) combining said crosslinkable non-water-soluble polymer with said non-aqueous diluent, subsequent to said coupling, to form said composition.

8. A process in accordance with claim 1 in which said composition further comprises a dead polymer.

9. A process in accordance with claim 5 in which said composition further comprises a dead polymer, and step (A) comprises (A.1) coupling said functionalizing agent to said non-water-soluble precursor polymer to form said crosslinkable non-water-soluble polymer, and (A.2) combining said crosslinkable non-water-soluble polymer with said non-aqueous diluent and said dead polymer, subsequent to said coupling, to form said composition.

10. A process in accordance with claim 1 in which said composition further comprises a reactive plasticizer.

11. A process in accordance with claim 5 in which said semi-solid composition further comprises a reactive plasticizer, and step (A) comprises (A.1) coupling said functionalizing agent to said non-water-soluble precursor polymer to form said crosslinkable non-water-soluble polymer, and (A.2) combining said crosslinkable non-water-soluble polymer with said non-aqueous diluent and said reactive plasticizer, subsequent to said coupling, to form said composition.

12. A process in accordance with claim 1 in which said composition further comprises a dead polymer and a reactive plasticizer.

13. A process in accordance with claim 5 in which said composition further comprises a dead polymer and a reactive plasticizer, and step (i) comprises (i.1) coupling said functionalizing agent to said non-water-soluble precursor polymer to form said crosslinkable non-water-soluble polymer, and (i.2) combining said crosslinkable non-water-soluble polymer with said non-aqueous diluent, said dead polymer, and said reactive plasticizer, subsequent to said coupling, to form said composition.

14. A process in accordance with claim 5 in which said non-water-soluble precursor polymer contains a plurality of sites capable of coupling to said functionalizing agent, and step (i) comprises coupling said functionalizing agent to about 0.2% to about 5% of said sites.

15. A process in accordance with claim 14 in which said sites consist of reactive groups selected from the group consisting of hydroxyl, amino, carboxylate, thiol, disulfide, anhydride, urethane, and epoxide groups.

16. A process in accordance with claim 15 in which said reactive group is a hydroxyl group.

17. A process in accordance with claim 16 in which said functionalizing agent is a member selected from the group consisting of epoxides, oxiranes, carbonyldiimidazoles, periodates, acid halides, alkyl halides, isocyanates, halohydrins, and anhydrides.

18. A process in accordance with claim 17 in which said functionalizing agent is an anhydride.

19. A process in accordance with claim 5 in which said non-water-soluble precursor polymer is a polymer of monomers selected from the group consisting of hydroxyethyl acrylate, hydroxyethyl methacrylate, hydroxypropyl acrylate, and hydroxypropyl methacrylate.

20. A process in accordance with claim 5 in which said non-water-soluble precursor polymer is a polymer of monomers comprising hydroxyethyl methacrylate.

21. A process in accordance with claim 5 in which said non-water-soluble precursor polymer is a copolymer of hydroxyethyl methacrylate, blue hydroxyethylmethacrylate, and methacrylic acid.

22. A process in accordance with claim 1 in which said crosslinkable non-water-soluble polymer is a product of (1) a polymer of monomers selected from the group consisting of hydroxyethyl acrylate, hydroxyethyl methacrylate, hydroxypropyl acrylate, and hydroxypropyl methacrylate, and (2) methacrylic anhydride.

23. A process in accordance with claim 1 in which said crosslinkable non-water-soluble polymer is a reaction product of (1) a polymer of monomers comprising hydroxyethyl methacrylate and (2) methacrylic anhydride.

24. A process in accordance with claim 15 in which said sites are thiol groups and said functionalizing agent is a member selected from the group consisting of haloacetyls, acid halides, alkyl halides, maleimides, aziridines, acrylating agents, pyridyl disulfides, disulfide reductants, and 5-thio-2-nitrobenzoic acid.

25. A process in accordance with claim 1 in which said crosslinkable non-water-soluble polymer is a product of a reaction between (1) a polymer of monomers selected from the group consisting of 3-(2,4,6-tribromo-3-methylphenoxy)-2-hydroxypropyl (meth)acrylate, 3-(2,4-dibromo-3-methylphenoxy)-2-hydroxypropyl (meth)acrylate, 3-(3-methyl-5-bromophenoxy)-2-hydroxypropyl (meth)acrylate, 2-(4-hydroxyethoxy-3,5-dibromophenyl)-2-(4-acryloxyethoxy-3,5-dibromophenyl)propane, 2-(4-hydroxyethoxy-3,5-dibromophenyl)-2-(4-acryloxy-3,5-dibromophenyl)propane, and 2-(4-hydroxydiethoxy-3,5-dibromophenyl)-2-(4-methacryloxydiethoxy-3,5-dibromophenyl)propane, and
(2) a functionalizing agent selected from the group consisting of epoxides, oxiranes, carbonyldiimidazoles, periodates, acid halides, alkyl halides, isocyanates, halohydrins, and anhydrides.

26. A process in accordance with claim 1 in which said crosslinkable non-water-soluble polymer is a product of a coupling reaction between
(1) a copolymer of hydroxyethyl methacrylate and a member selected from the group consisting of methacrylic acid, acrylic acid, N-vinyl pyrrolidone, dimethyl acrylamide, and vinyl alcohol, and
(2) a functionalizing agent that when coupled to said copolymer is capable of undergoing a crosslinking reaction.

27. A process in accordance with claim 1 in which said crosslinkable non-water-soluble polymer is a product of a coupling reaction between
(1) a copolymer of hydroxyethyl methacrylate and methacrylic acid, and
(2) a methacrylic anhydride.

28. A process in accordance with claim 1 in which said non-aqueous diluent is a member selected from the group consisting of polyethylene glycol and monomethoxy, dimethoxy, monoethoxy, and diethoxy ethers of polyethylene glycol, polypropylene glycol and monomethoxy, dimethoxy, monoethoxy, and diethoxy ethers of polypropylene glycol, polybutylene glycol and monomethoxy, dimethoxy, monoethoxy, and diethoxy ethers of polybutylene glycol, polyglycerol and monomethoxy, dimethoxy, monoethoxy, and diethoxy ethers of polyglycerol, and alkylated glucosides.

29. A process in accordance with claim 1 in which said non-aqueous diluent is a member selected from the group consisting of polyethylene glycol, polypropylene glycol, polybutylene glycol, polyglycerol, and alkylated glucosides.

30. A process in accordance with claim 1 in which said non-aqueous diluent is polyethylene glycol.

31. A process for the manufacture of a molded hydrogel article, said process comprising:
(a) effecting polymerization of a monomer to form a non-water-soluble polymer which when crosslinked and saturated with water forms a hydrogel containing a predetermined volumetric proportion of water, said monomer having a reactive group that, subsequent to polymerization of said monomer, is capable of coupling to a functionalizing agent defined as an agent that when coupled to said reactive group is capable of undergoing a crosslinking reaction;
(b) contacting said non-water-soluble polymer with a functionalizing agent as defined above to convert said non-water soluble polymer to a crosslinkable non-water soluble polymer;
(c) casting a composition comprising:
(i) said crosslinkable non-water soluble polymer and
(ii) a non-aqueous diluent that is inert to said crosslinking reaction, said non-aqueous diluent being in a volumetric proportion substantially equal to said volumetric proportion of water in said hydrogel, in a mold under conditions that cause said crosslinking reaction to occur and that convert said composition to a non-aqueous gel; and
(d) substituting an aqueous liquid for said non-aqueous diluent to convert said non-aqueous gel to a hydrogel.

32. A process in accordance with claim 31 in which said aqueous liquid is an aqueous physiological saline solution.

33. A process in accordance with claim 31 in which step (b) comprises contacting said liquid prepolymer mixture with an amount of said functionalizing agent selected to cause coupling of said functionalizing agent to from about 0.2% to about 5% of said reactive groups.

34. A process in accordance with claim 31 in which said reactive group is a member selected from the group consisting of hydroxyl, amino, carboxylate, thiol, disulfide, anhydride, urethane, and epoxide groups.

35. A process in accordance with claim 31 in which said reactive group is a hydroxyl group.

36. A process in accordance with claim 31 in which said monomer is a monomer or monomer mixture that polymerizes to a member selected from the group consisting of poly(hydroxyethyl acrylate), poly(hydroxyethyl methacrylate), poly(hydroxypropyl acrylate), poly(hydroxypropyl methacrylate), polyethylene glycol, cellulose, dextran, polyvinyl alcohol, poly(vinyl acetate-co-vinyl alcohol), polyethylene-co-vinyl alcohol, and polybisphenol A.

37. A process in accordance with claim 31 in which said monomer is a member selected from the group consisting of hydroxyethyl acrylate, hydroxyethyl methacrylate, hydroxypropyl acrylate, and hydroxypropyl methacrylate.

38. A process in accordance with claim 31 in which said monomer is hydroxyethyl methacrylate.

39. A process in accordance with claim 31 in which said monomer is a mixture of hydroxyethyl methacrylate, blue hydroxyethyl methacrylate, and methacrylic acid.

40. A process in accordance with claim 31 in which said reactive group is a hydroxyl group and said functionalizing agent is a member selected from the group consisting of epoxides, oxiranes, carbonyldiimidazoles, periodates, acid halides, alkyl halides, isocyanates, halohydrins, and anhydrides.

41. A process in accordance with claim 31 in which said reactive group is a hydroxyl group and said functionalizing agent is an anhydride.

42. A process in accordance with claim 31 in which said monomer is hydroxyethyl methacrylate and said functionalizing agent is methacrylic anhydride.

43. A process in accordance with claim 31 in which said reactive group is a thiol group and said functionalizing agent is a member selected from the group consisting of haloacetyls, acid halides, alkyl halides, maleimides, aziridines, acryloylsacrylating agents, pyridyl disulfides, disulfide reductants, and 5-thio-2-nitrobenzoic acid.

44. A process in accordance with claim 31 in which said monomer is a member selected from the group consisting of 3-(2,4,6-tribromo-3-methylphenoxy)-2-hydroxypropyl (meth)acrylate, 3-(2,4-dibromo-3-methylphenoxy)-2-hydroxypropyl (meth)acrylate, 3-(3-methyl-5-bromophenoxy)-2-hydroxypropyl (meth)acrylate, 2-(4-hydroxyethoxy-3,5-dibromophenyl)-2-(4-acryloxyethoxy-3,5-dibromophenyl)propane, 2-(4-hydroxyethoxy-3,5-dibromophenyl)-2-(4-acryloxy-3,5-dibromophenyl)propane, and 2-(4-hydroxydiethoxy-3,5-dibromophenyl)-2-(4-methacryloxydiethoxy-3,5-dibromophenyl)propane, and said functionalizing agent is a member selected from the group consisting of epoxides, oxiranes, carbonyldiimidazoles, periodates, acid halides, alkyl halides, isocyanates, halohydrins, and anhydrides.

45. A process in accordance with claim 31 in which said monomer is hydroxyethyl methacrylate and step (a) is performed in the presence of a co-monomer selected from the group consisting of methacrylic acid, acrylic acid, N-vinyl pyrrolidone, dimethyl acrylamide, and vinyl alcohol, and said non-water-soluble precursor polymer is a copolymer.

46. A process in accordance with claim 45 in which said co-monomer is methacrylic acid.

47. A process in accordance with claim 31 in which said monomer is hydroxyethyl methacrylate and step (a) is performed in the presence of co-monomers blue hydroxyethyl methacrylate and methacrylic acid.

48. A process in accordance with claim 31 in which said non-aqueous diluent is a member selected from the group consisting of polyethylene glycol and monomethoxy, dimethoxy, monoethoxy, and diethoxy ethers of polyethylene glycol, polypropylene glycol and monomethoxy, dimethoxy, monoethoxy, and diethoxy ethers of polypropylene glycol, polybutylene glycol and monomethoxy, dimethoxy, monoethoxy, and diethoxy ethers of polybutylene glycol, polyglycerol and monomethoxy, dimethoxy, monoethoxy, and diethoxy ethers of polyglycerol, and alkylated glucosides.

49. A process in accordance with claim 31 in which in which said non-aqueous diluent is a member selected from the group consisting of polyethylene glycol, polypropylene glycol, polybutylene glycol, polyglycerol, and alkylated glucosides.

50. A process in accordance with claim 31 in which in which said non-aqueous diluent is polyethylene glycol.

51. A process in accordance with claim 31 in which step (a) comprises exposing said monomer to an elevated temperature in the presence of a thermal polymerization initiator.

52. A process in accordance with claim 51 in which said thermal polymerization initiator is a member selected from the group consisting of lauryl peroxide, benzoyl peroxide, dicumyl peroxide, t-butyl hydroperoxide, azobisisobutyronitrile, potassium persulfate, and ammonium persulfate.

53. A process in accordance with claim 31 in which step (c) comprises exposing said composition to light in the presence of a photoinitiator.

54. A process in accordance with claim 53 in which said photoinitiator is a member selected from the group consisting of benzoin methyl ether, 1-hydroxycyclohexyl phenyl ketone, 2-hydroxy-2-methyl-1-phenylpropane-1-one, 4,4′-azobis(4-cyanovaleric acid), and bis(2,6-dimethoxybenzoyl)-2,4,4-trimethylpentyl phosphine oxide.

55. A process in accordance with claim 31 in which said non-water-soluble precursor polymer has a molecular weight of from about 10,000 to about 1,000,000.

56. A process in accordance with claim 31 in which said non-water-soluble precursor polymer has a molecular weight of from about 10,000 to about 300,000.

57. A process in accordance with claim 31 in which said non-water-soluble precursor polymer has a molecular weight of from about 50,000 to about 150,000.

58. A composition that is curable to a non-aqueous gel, said composition comprising a crosslinkable non-water-soluble polymer dissolved in a non-aqueous diluent to form a semi-solid, said crosslinkable polymer bearing functional groups that are capable of crosslinking said crosslinkable polymer in a crosslinking reaction to which said non-aqueous diluent is inert.

59. A composition in accordance with claim 58 in which said crosslinkable polymer is a polymer obtained by reaction of a hydroxyl-substituted precursor polymer selected from the group consisting of poly(hydroxyethyl acrylate), poly(hydroxyethyl methacrylate), poly(hydroxypropyl acrylate), poly(hydroxypropyl methacrylate), polyethylene glycol, cellulose, dextran, polyvinyl alcohol, poly(vinyl acetate-co-vinyl alcohol), polyethylene-co-vinyl alcohol, and polybisphenol A, with a member selected from the group consisting of epoxides, oxiranes, carbonyldiimidazoles, periodates, acid halides, alkyl halides, isocyanates, halohydrins, and anhydrides.

60. A composition in accordance with claim 58 in which said crosslinkable polymer is a polymer obtained by reaction of a hydroxyl-substituted precursor polymer selected from the group consisting of poly(hydroxyethyl acrylate), poly(hydroxyethyl methacrylate), poly(hydroxypropyl acrylate), and poly(hydroxypropyl methacrylate) with an anhydride.

61. A composition in accordance with claim 58 in which said crosslinkable polymer is a polymer of monomers comprising hydroxyethyl methacrylate functionalized by reaction with methacrylic anhydride.

62. A composition in accordance with claim 58 in which said crosslinkable polymer is a copolymer of monomers comprising hydroxyethyl methacrylate and methacrylic acid functionalized by reaction with methacrylic anhydride.

63. A composition in accordance with claim 58 in which said crosslinkable polymer is a copolymer of hydroxyethyl methacrylate, blue hydroxyethyl methacrylate, and methacrylic acid, functionalized by reaction with methacrylic anhydride.

64. A composition in accordance with claim 58 further comprising a dead polymer.

65. A composition in accordance with claim 58 further comprising a reactive plasticizer.

66. A composition in accordance with claim 58 further comprising a dead polymer and a reactive plasticizer.

67. A composition in accordance with claim 61 in which from about 0.2% to about 5% of the hydroxy groups of said polymer are coupled to said functional groups.

68. A composition in accordance with claim 58 in which said crosslinkable polymer has a molecular weight of from about 10,000 to about 1,000,000.

69. A composition in accordance with claim 58 in which said crosslinkable polymer has a molecular weight of from about 10,000 to about 300,000.

70. A composition in accordance with claim 58 in which said crosslinkable polymer has a molecular weight of from about 50,000 to about 150,000.

71. A composition in accordance with claim 58 in which said non-aqueous diluent is a member selected from the group consisting of polyethylene glycol, polypropylene glycol, polybutylene glycol, polyglycerol, and alkylated glucosides.

72. A composition in accordance with claim 58 in which said crosslinkable polymer is a copolymer of monomers comprising hydroxymethyl methacrylate and methacrylic acid of which from about 0.2% to about 5% of the hydroxyl groups are functionalized with methacrylic anhydride.

73. A composition in accordance with claim 58 in which said crosslinkable polymer is a copolymer of monomers comprising hydroxymethyl methacrylate and methacrylic acid of which from about 0.2% to about 5% of the hydroxyl groups are functionalized with methacrylic anhydride and whose molecular weight is from about 50,000 to about 150,000.
